(19) United States
(12) Patent Application Publication
(10) Pub. No.: US 2025/0154700 A1
(43) Pub. Date: May 15, 2025

(54) POROUS NON-WOVEN PTFE COMPOSITIONS AND METHODS OF FORMING

(71) Applicant: Donaldson Company, Inc., Bloomington, MN (US)

(72) Inventors: Shane Lawson, Waconia, MN (US); Elena T. Ewaldz, Minneapolis, MN (US); Andrew J. Reuter, Minneapolis, MN (US); Yehya A. Elsayed, Bloomington, MN (US)

(21) Appl. No.: 18/948,051

(22) Filed: Nov. 14, 2024

Related U.S. Application Data
(60) Provisional application No. 63/599,191, filed on Nov. 15, 2023.

(51) Int. Cl. D04H 3/007

(52) U.S. Cl. CPC D04H 3/007; D10B 2321/042; D10B 2401/10; D10B 2403/0242

(57) ABSTRACT

Tapes, expanded tapes, and methods of making the same. The tapes and expanded tapes include long-strand PTFE fibrils, short-strand PTFE fibrils, and an oriented network. The oriented network includes nodes. The nodes include short-strand PTPE fibrils. Tapes may include a plurality of through pores. Expanded tapes may include a plurality of through pores.

### CROSS-REFERENCE TO RELATED APPLICATION

This application claims the benefit of U.S. Provisional Patent Application No. 63/599,191, filed Nov. 15, 2023, which is incorporated herein by reference in its entirety.

### BACKGROUND

Catalysts and sorbents (adsorbents and absorbents) can be used to remove unwanted chemicals from a fluid (e.g., a gas or a liquid). For example, catalysts can be used to destroy ozone. Sorbents can be used to isolate or remove acidic molecules, basic molecules, ozone, or other various organic or inorganic compounds from fluids. Catalysts and sorbents may be difficult to handle when in a powdered or particulate form. As such, catalysts and sorbents are often secured onto or into a support. Securing a catalyst or absorbent onto a support may make the catalyst or absorbent easier to handle; however, securing the catalyst or absorbent to the support may reduce the surface area of the catalyst or absorbent available to remove the unwanted chemicals from the fluid. Additionally, the physical and chemical properties of the support may impact the functionality of the catalysts (e.g., catalytic efficiency) or sorbent. Furthermore, the physical and chemical properties of the support may impact the ultimate configuration of a product (e.g., a filter) that includes a catalyst- or absorbent-functionalized support. Ideally, a catalyst- or sorbent-functionalized support has one or more of the following characteristics: is readily shape engineered; has the catalyst or absorbent fixed in a configuration such as to display a large surface area of the catalyst or the sorbent; and resists mechanical and chemical degradation.

### SUMMARY OF THE DISCLOSURE

In one aspect, the present disclosure describes a tape. The tape includes a machined matrix. The machined matrix has a machined direction. The machined matrix includes long-strand PTFE fibrils, nodes, and a plurality of through pores. The long-strand PTFE fibrils form an oriented network. The oriented network includes the long-strand PTFE fibrils. The long-strand PTFE fibrils define a longitudinal direction. The nodes are distributed among the oriented network. The nodes include active particles and short-strand PTFE distributed among the active particles. In some embodiments, the plurality of through pores have an average pore opening of 50 micrometers or greater.

In another aspect, the present disclosure describes an expanded tape. The expanded tape includes an expanded matrix. The expanded matrix has an expanded direction. The expanded matrix includes long-strand PTFE fibrils, nodes, and a plurality of through pores. The long-strand PTFE fibrils form an oriented network. The oriented network includes the long-strand PTFE fibrils. The long-strand PTFE fibrils define a longitudinal direction. The nodes include active particles and short-strand PTFE distributed among the active particles. In some embodiments, the plurality of through pores have an average pore opening of 50 micrometers or greater.

In another aspect, the present disclosure describes a method of forming a tape. The method may include, machining a fibrous matrix in a machined direction to form the machine matrix. The fibrous matrix includes long-strand PTFE fibrils, short-strand PTFE fibrils, and active particles. In some embodiments, the method includes forming the plurality of through pores.

In another aspect, the present disclosure describes a method of forming an expanded tape. An expanded tape may be formed by expanding a machined matrix. In some embodiments, the method includes forming the plurality of through pores.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### Definitions

All scientific and technical terms used herein have meanings commonly used in the art unless otherwise specified. The definitions provided herein are to facilitate understanding of certain terms used frequently herein and are not meant to limit the scope of the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The terms, “have,” “having,” “include,” “including,” “comprise,” “comprising,” or the like are used in their open-ended sense, and generally mean “including, but not limited to.” The phrase “consisting of” means including, and limited to, whatever follows the phrase “consisting of.” Thus, the phrase “consisting of” indicates that the listed elements are required or mandatory, and that no other elements may be present. The phrase “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may, or may not, be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. At the very least, and not as an attempt to limit the doctrine of equivalents to the scope of the claims, each numerical parameter should at least be construed in light of the number of reported significant digits and by applying ordinary rounding techniques.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

As used herein, the term “room temperature” or “ambient temperature” refers to a temperature of 20 degrees Celsius to 25 degrees Celsius.

The term “in the range” or “within a range” (and similar statements) includes the endpoints of the stated range.

Reference throughout this specification to “one aspect,” “an aspect,” “aspects,” “one embodiment,” “an embodiment,” “certain embodiments,” “one or more embodiments,” or “some embodiments,” etc., means that a particular feature, configuration, composition, or characteristic described in connection with the embodiment or aspect is included in at least one embodiment or aspect of the disclosure. Thus, the appearances of such phrases in various places throughout this specification are not necessarily referring to the same embodiment or aspect of the disclosure. Furthermore, the particular features, configurations, compositions, or characteristics may be combined in any suitable manner in one or more embodiments or aspects.

The term “on” when used in the context of a composition or a hydrated solid disposed on a surface or a substrate, includes both the composition or the hydrated solid directly or indirectly (e.g., on a primer layer) disposed on (e.g., applied to) the surface or a substrate. Thus, for example, a composition or a hydrated solid disposed on a pre-treatment layer or a primer layer overlying a substrate constitutes a composition or a hydrated solid disposed on the substrate.

For any method disclosed herein that includes discrete steps, the steps may be performed in any feasible order. And, as appropriate, any combination of two or more steps may be performed simultaneously.

The complete disclosure of all patents, patent applications, and publications, and electronically available material cited herein are incorporated by reference in their entirety. In the event that any inconsistency exists between the present disclosure and the disclosure(s) of any document incorporated herein by reference, the present disclosure shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

### BRIEF DESCRIPTION OF THE FIGURES

FIG. 1 is a schematic representation of an illustrative tape at two magnification powers that is consistent with embodiments of the present disclosure.

FIG. 2 is a schematic showing the relationship between the longitudinal direction defined by the long-strand PTFE fibrils and the machined direction.

FIG. 3A-3B are schematics showing the relationship of between the longitudinal direction defined by the long-strand PTFE fibrils and the machined direction when the angle defined by the longitudinal direction and the machined direction is 0 degrees (FIG. 3A) and greater than 0 degrees (FIG. 3B).

FIG. 4A-4B are schematics showing an embedded structure (FIG. 4A) and a conglomerated structure (FIG. 4B).

FIG. 5 is a schematic representation of an illustrative expanded tape at two magnification powers that is consistent with embodiments of the present disclosure.

FIG. 6 is a schematic showing the relationship between the longitudinal direction defined by the long-strand PTFE fibrils and the expanded direction.

FIG. 7A-7B are schematics showing the relationship of between the longitudinal direction, the machined direction, and the expanded direction when the angle defined by the longitudinal direction and the expanded direction is 0 degrees (FIG. 7A) and greater than 0 degrees (FIG. 7B).

FIG. 8A-8B are flow diagrams outlining a first method (FIG. 8A) and a second method (FIG. 8B) for making tapes consistent with embodiments of the present disclosure.

FIG. 9 is a flow diagram outlining a method for making a fibrous matrix consistent with embodiments of the present disclosure.

FIG. 10 is a schematic representation of an illustrative fibrous matrix at two magnification powers that is consistent with embodiments of the present disclosure.

FIG. 11A-11B are flow diagrams outlining a first method (FIG. 11A) and a second method (FIG. 11B) for making an expanded tape consistent with embodiments of the present disclosure.

FIG. 12 is a schematic illustrating the dimensions and the relationship between the dimensions of a machined matrix and an expanded matrix formed from expanding the machined matrix.

FIG. 13 is a scanning electron micrograph of an expanded tape that includes 72.7 wt-% of CARULITE. The longitudinal direction 60, machined direction 50, and expanded direction 90 are shown.

FIG. 14 is a scanning electron micrograph of convention expanded PTFE that does not include active particles.

FIG. 15 is an image of a failed fibrous matrix extrusion through a channeled honeycomb die.

FIG. 16 is an image of a tape formed by hand rolling a fibrous matrix.

FIG. 17A-17D are scanning electron micrographs of fibrous matrixes having 54.7 wt-% active particles (FIG. 17A), 65.5 wt-% active particles (FIG. 17B), 72.7 wt-% active particles (FIG. 17C), and 93.7 wt-% active particles (FIG. 17D).

FIG. 18 is a plot showing the ozone destruction rates of flat catalyst coated plates and self-standing catalyst tapes at 150,000 ppb ozone and 1.3 L/min flowrate.

FIG. 19 is a schematic illustrating how a machined matrix was cut into segments at various angles for expansion in the Examples. The relationship between the machined direction and the expanded direction is also shown.

FIG. 20A-20B are stress/strain curves for a machined matrix expanded at various rates and an expansion temperature of 175 degrees Celsius (FIG. 20A) and 200 degrees Celsius (FIG. 20B) with a cut in parallel to the machined direction.

FIG. 21A-21C are scanning electron micrographs of an expanded matrix formed from expanding a machined matrix in an expanded direction that was the same as the machined direction at an expansion rate of 10 mm/s (FIG. 21A), 1 mm/s (FIG. 21B), and 0.1 mm/s (FIG. 21C).

FIG. 22 is a scanning electron micrograph of an expanded matrix formed from expanding a machined matrix in an expanded direction that was the same as the machined direction at an expansion rate of 0.1 mm/s and an expansion temperature of 175 degrees Celsius.

FIG. 23 is stress/strain curves for a machined matrix expanded at in an expanded direction that in the cross direction of the machined direction. The machined matrix was expanded at various rates and an expansion temperature of 200 degrees Celsius.

FIG. 24A-24C are scanning electron micrographs of an expanded matrix formed from expanding a machined matrix in an expanded direction that was in the cross direction to the machined direction an expansion rate of 10 mm/s (FIG. 24A), 1 mm/s (FIG. 24B), and 0.1 mm/s (FIG. 24C).

FIG. 25A-25C are several scanning electron micrographs of a catenated structure (FIG. 25A), a first conglomerated structure (FIG. 25B), and a second conglomerated structure (FIG. 25C) of an expanded matrix. The expanded matrix included 72.7 wt-% CARULITE and was expanded at 0.1 mm per second at 175 degrees Celsius.

FIG. 26 is a scanning electron micrograph of a machined matrix with the longitudinal direction of the long-strand PTFE fibrils encircled.

FIG. 27A-27B are scanning electron micrographs of a machined matrix (27A) and an expanded matrix (FIG. 27B) formed by expanding the machined matrix of FIG. 27A.

FIG. 28A-28B are scanning electron micrographs of the surface of a first machined matrix before (FIG. 28A) and after (FIG. 29B) formation of through pores.

FIG. 29A-29B are scanning electron micrographs of the surface of a second machined matrix before (FIG. 29A) and after (FIG. 29B) formation of through pores.

FIG. 30 is a plot showing the air permeability of the machined matrix of FIG. 29A-29B before and after the formation of through pores.

FIG. 31A-31B are scanning electron micrographs at two magnifications of a machined matrix having through pores.

FIG. 32 is the distribution of fibril angles measured from 38 fibrils in FIG. 14 and FIG. 22 relative to the x-axis.

### DETAILED DESCRIPTION OF ILLUSTRATIVE EMBODIMENTS

The present disclosure describes a tape, an expanded tape, and methods of making the tape and expanded tape. The tapes and expanded tapes include active particles that may be useful as sorbents and/or catalysts. One or more of the tapes and/or expanded tapes may be configured into structure into a higher order structure, such as, for example, a honeycomb structure, a cinnamon roll structure, a pleated structure, or a packed bed structure. The tapes, expanded tapes, and higher order structures containing the same may be used in fluid filters (e.g., gas and/or liquid) filters.

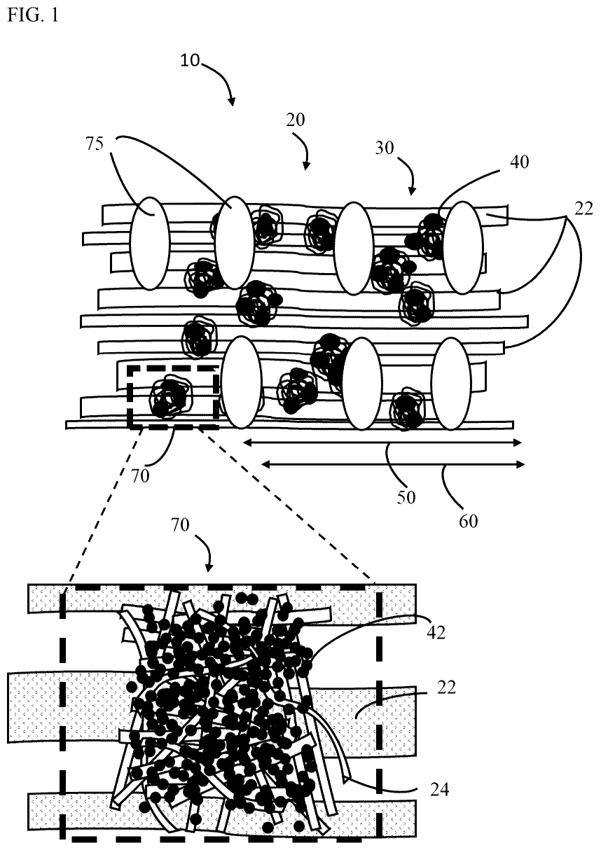

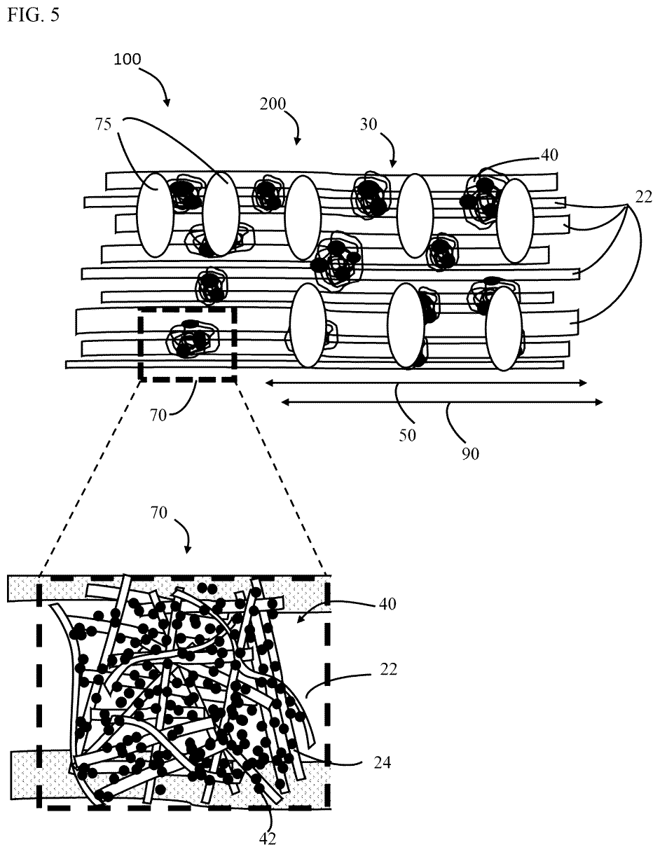

FIG. 1 and FIG. 5 show a schematic illustration of a tape 10 (FIG. 1) and a schematic illustration of an expanded tape 100 (FIG. 5) consistent with embodiments of the present disclosure. A tape is a sheet of material having two opposing major surfaces, each major surface defining two major dimensions (e.g., length and width). A tape also has a thickness that may be several orders of magnitude smaller than the largest major dimension. The thickness of a tape may be substantially uniform. An expanded tape (100 in FIG. 5) results from exposing a tape to one or more forces (e.g., pushing, pulling, stretching, and the like) that causes one or both of the major dimensions to increase without the addition of material. The expanded tape 100 (FIG. 5) of the present disclosure includes or is formed of a tape or machined matrix that has undergone expansion.

The tapes and expanded tapes of the present disclosure include PTFE fibrils and active particles 42. In some embodiments, the tapes and expanded tapes include short-strand PTFE fibrils 24 and long-strand PTFE fibrils 22.

Short-strand PTFE fibril and long-strand PTFE fibril are used relative to one another. A short-strand PTFE fibril has a length that is shorter than a long-strand PTFE fibril as measure per the Dimensional Analysis Test Method. A plurality of short-strand PTFE fibrils has an average length that is shorter than the average length of a plurality of long-strand PTFE fibrils as measured per the Dimensional Analysis Test Method. The length of a fibril is the largest dimension of the fibril.

The PTFE fibrils (short-strand and long-strand) are formed from PTFE resin. PTFE resin may include PTFE polymers, oligomers, monomers, or any combination thereof. PTFE resin may be a solid or a liquid. The PTFE resin includes particles that include the PTFE polymers, oligomers, monomers, or any combination thereof. Each particle of the PTFE resin has a resin particle size. The resin particle size is the greatest cross-sectional distance across a resin particle.

Short-strand PTFE fibrils are formed from short-strand PTFE resin. Short-strand PTFE resin may be obtained or formed as an emulsion with a dispersant (e.g., water and/or an organic solvent) and/or a surfactant. As used herein, the use of short-strand PTFE resin includes the use of resin and/or the use of a short-strand PTFE emulsion with a dispersant and/or a surfactant. In some embodiments, short-strand PTFE resin has an average resin particle size of 1 micrometer (micrometers) to 9 micrometers, such as 3 micrometers to 5 micrometers as measured according to the Dimensional Analysis Test Method. Upon incorporation of the short-strand PTFE resin into the matrixes, tapes, and expanded tapes of the present disclosure (e.g., using the methods of the present disclosure), the resin particles of the short-strand PTFE resin lengthen (e.g., fibrilize) to form short-strand PTFE fibrils.

Each short-strand PTFE fibril has a diameter and a length. The diameter, the length, or both of each short-strand PTFE fibril may change throughout the process of making the tape or expanded tape. For example, the diameter, the length, or both, of short-strand PTFE fibrils in a tape may be different that the diameter, the length, or both, of the short-strand PTFE fibrils in an expanded tape. For example, the length of a short-strand PTFE fibril in an expanded matrix may be 101% to 200% the length of the same fibril in the machined matrix prior to expansion. The diameter, length, or both of the short-strand PTFE fibril may change during the processing of a fibrous matrix (described herein) to a machined matrix (in a tape of the present disclosure) to an expanded matrix (in an expanded tape of the present disclosure) as described herein. In embodiments, the short-strand PTFE fibrils in the tape and/or the expanded tape have an average length of 30 micrometers or less (down to 1 micrometer), preferably 20 micrometers or less (down to 1 micrometer), 10 micrometers or less (down to 1 micrometer), or 5 micrometers or less (down to 1 micrometers) as measured according to the Dimensional Analysis Test Method. In some embodiments, short-strand PTFE fibrils in the tape and/or the expanded tape have an average length of 1 micrometer or greater, 5 micrometers or greater, 10 micrometers or greater, or 20 micrometers or greater as measured according to the Dimensional Analysis Test Method. In some embodiments, the short-strand PTFE fibrils of tape and/or the expanded tape have an average diameter of 0.01 micrometers or greater, 0.05 micrometers or greater, 0.3 micrometers or greater, or 0.5 micrometers or greater as measured according to the Dimensional Analysis Test Method. In some embodiments, the short-strand PTFE fibrils the tape and/or the expanded tape have an average diameter of 1 micrometer or less, 0.5 micrometers or less, or 0.3 micrometers or less as measured according to the Dimensional Analysis Test Method.

Long-strand PTFE fibrils are formed from long-strand PTFE resin. In some embodiments, the long-strand PTFE resin has an average resin particle size of 10 micrometers or greater, 25 micrometers or greater, 50 micrometers or greater, 100 micrometers or greater, 200 micrometers or greater, 200 micrometers or greater, and up to 1000 micrometers as measured according to the Dimensional Analysis Test Method. Upon incorporation of the long-strand PTFE resin into the matrices of the present disclosure (e.g., using the methods of the present disclosure), the particles of the long-strand PTFE resin lengthen (e.g., fibrilize) to form the long-strand PTFE fibrils.

Each long-strand PTFE fibril has a diameter and a length. The diameter, the length, or both of the long-strand PTFE fibrils may change throughout the process of making the tape and/or the expanded tape. For example, the diameter, the length, or both, of the long-strand PTFE fibrils in a tape may be different that the diameter, the length, or both, of the long-strand PTFE fibrils in an expanded tape. The diameter, length, or both, of the long-strand PTFE fibril may change during the processing of a fibrous matrix (described herein) to a machined matrix (in a tape of the present disclosure) to an expanded matrix (in an expanded tape of the present disclosure) as described herein. For example, the length of a long-strand PTFE fibril in an expanded matrix may be 101% to 200% the length of the same fiber in the machined matrix prior to expansion. In embodiments, the long-strand PTFE fibrils in the tape and/or the expanded tape have an average length of 40 micrometers or greater, 60 micrometers or greater, 80 micrometers or greater, 100 micrometers or greater, 200 micrometers or grater, 300 micrometers or greater, 400 micrometers or greater, 500 micrometers or greater 1000 micrometers or greater, 2000 micrometers or greater, or 5000 micrometers or greater as measured according to the Dimensional Analysis Test Method. In embodiments, the long-strand PTFE fibrils in the tape and/or the expanded tape have an average length an average length of 10000 micrometers or less, 5000 micrometers or less, 2000 micrometers or less, 1000 micrometers or less, 500 micrometers or less, 400 micrometers or less, 300 micrometers or less, 200 micrometers or less, 100 micrometers or less, 80 micrometers or less, or 60 micrometers or less as measured according to the Dimensional Analysis Test Method. Without wishing to be bound by theory, it is thought that the long-strand PTFE fibrils may impart some degree of mechanical robustness to the expanded matrix resulting in an expanded matrix that is membrane-like.

Without wishing to be bound by theory, it is thought that the particles of the short-strand PTFE resin and particles of the long-strand PTFE resin do not merge to form PTFE fibrils; that is, it is thought that particles of the long-strand PTFE resin form long-strand PTFE fibrils and the particles of the short-strand PTFE resin form short-strand PTFE fibrils. A short-strand PTFE fibril may be located within a long-strand PTFE fibril; however, they are thought to be separate entities.

In some embodiments, a tape and/or an expanded tape of the present disclosure include 0.01 weight-% (wt-%) or greater, 1 wt-% or greater, 5 wt-% or greater, 10 wt-% or greater, 15 wt-% or greater, 25 wt-% or greater, 45 wt-% or greater, 55 wt-% or greater, or 65 wt-% or greater of PTFE fibrils (the total of short-strand PTFE fibrils and long-strand PTFE fibrils) based on the total weight of the tape or expanded tape per the Compositional Analysis Test Method. In some embodiments, a tape and/or an expanded tape of the present disclosure include 80 wt-% or less, 65 wt-% or less, 55 wt-% or less, 45 wt-% or less, 25 wt-% or less, or 15 wt-% or less, 10 wt-% or less, 5 wt-% or less, or 1 wt-% or less of the plurality of PTFE fibrils based on the total weight of the tape or expanded tape per the Compositional Analysis Test Method.

The weight ratio of short-strand PTFE fibrils to long-strand PTFE fibrils in the tape and/or the expanded tape may vary depending on the desired end application of the tape and/or the expanded tape. The ratio and weight percentages of short-strand PTFE fibrils and long-strand PTFE fibrils in the tape and/or the expanded tape are calculated from the mass of short-strand PTFE resin and the mass of long-strand PTFE resin used to make the fibrous matrix from which the tape and the expanded tape are formed. In some embodiments, the ratio by weight of short-strand PTFE fibrils to long-strand PTFE fibrils may be 50 parts to 10 parts short-strand PTFE fibrils for every 1 parts long-strand PTFE fibrils, for example, 30 parts to 10 parts short-strand PTFE fibrils for every 1 parts long-strand PTFE fibrils.

Stated differently, the total amount of PTFE (i.e., the sum of the short-strand PTFE fibrils and long-strand PTFE fibrils) in the tape and/or the expanded tape may include varying weight percentages of short-strand PTFE fibrils and long-strand PTFE fibrils. In some embodiments, the tape and/or the expanded tape includes 5 wt-% or greater, 15 wt-% or greater, 25 wt-% or greater, 45 wt-% or greater, 55 wt-% or greater, or 65 wt-% or greater of short-strand PTFE fibrils based on the total weight of the tape and/or the expanded tape per the Compositional Analysis Test Method. In some embodiments, the tape and/or the expanded tape includes 80 wt-% or less, 65 wt-% or less, 55 wt-% or less, 45 wt-% or less, 25 wt-% or less, or 15 wt-% or less of short-strand PTFE fibrils based on the total weight of the tape and/or the expanded tape per the Compositional Analysis Test Method. In some embodiments, the tape and/or the expanded tape includes 0.01 wt-% or greater, 1 wt-% or greater, 5 wt-% or greater, or 10 wt-% or greater of long-strand PTFE fibrils based on the total weight of the tape and/or the expanded tape per the Compositional Analysis Test Method. In some embodiments, the tape and/or the expanded tape includes 15 wt-% or less, 10 wt-% or less, 5 wt-% or less, or 1 wt-% or less of the long-strand PTFE fibrils based on the total weight of the tape and/or the expanded tape per the Compositional Analysis Test Method.

The average diameter of the PTFE fibrils, the average length of the PTFE fibrils, and the average resin particle size may be determined using various methods including microscopy, such as scanning electron microscopy (SEM; see the Dimensional Analysis Test Method) or transmission electron microscopy (TEM).

The short-strand PTFE fibrils and the long-strand PTFE fibrils may include various forms of PTFE such as C3-PTFE, C2-PTFE, C1-PTFE, or combinations thereof. C1-PTFE is a polytetrafluoroethylene polymer that includes the repeating group —(CF₂—C(F) (CF₃))—. C2-PTFE is a polytetrafluoroethylene polymer that includes the —(CF₂—C(F) (CF₂—CF₃))— repeating group. C3-PTFE is a polytetrafluoroethylene polymer that includes the —(CF₂—C(F) (CF₂—CF₂—CF₃))— repeating group. In some cases, it may be desirable to decrease the amount of fluorine in the final composition and/or decrease the amount of fluorine-carbon bonds used in the production of the PTFE. In some embodiments, the PTFE resin used to form the PTFE fibrils, and therefore the PTFE fibrils in the matrix, may include any combination of C1 short-strand PTFE, C2 short-strand PTFE, C3 short-strand PTFE, C1 long-strand PTFE, C2 long-strand PTFE, or C3-long-strand PTFE.

The tapes and expanded tapes of the present disclosure include active particles. An active particle is a particle that includes at least one component that can participate in a chemical reaction (e.g., as a catalyst) and/or can act as an adsorbent. The physical and/or chemical functionality of the particles making up the active particles may vary based on the intended use of a given tape or expanded tape. The plurality of active particles may include a catalyst, a sorbent such as an adsorbent and/or an absorbent, a growth seed, a metal-organic framework, an electroactive material, or any combination thereof.

In some embodiments, the active particles include a catalyst. A “catalyst” is a chemical species that alters the rate of one or more reactions without being consumed. The expanded matrix may include any suitable catalyst, or a combination of catalysts, for facilitating any desired reaction. In some embodiments, desirable reactions may include nitrobenzene reduction, NOₓ reduction, hydrogenation, or any combination thereof. Catalysts that can remove, prevent, and/or reduce the emission of harmful gases into the atmosphere may be of particular interest. For example, the plurality of active particles may include a catalyst capable of reducing and/or converting one or more nitrogen oxide (NOₓ) compounds (e.g., nitric oxide, nitrogen dioxide, dinitrogen trioxide, and/or nitrate) into diatomic nitrogen. The catalysts may be grafted onto a support such as an adsorbent (described elsewhere herein).

In some embodiments, the catalyst can destroy ozone (O₃); that is, the catalyst is able to convert ozone (O₃) to oxygen (O₂) by way of bond rearrangement. Examples of catalysts capable of ozone destruction include silicates such as iron silicates, iron manganese silicates, zinc iron silicates, or any combination thereof; transition metal oxides such as zinc oxide, manganese oxide, copper oxide, cerium dioxide, or any combination thereof; reduced metals (i.e., zero-valent metals) that include titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; carbonates such as barium carbonate, magnesium carbonate, calcium carbonate, strontium carbonate, or any combination thereof; zeolites; or any combination thereof. As used herein, the term “zeolite” refers to aluminosilicate compounds made up of aluminum, oxygen, silicon, and one or more counterions.

In some embodiments, the active particles include a catalyst capable of ozone destruction that includes manganese oxide (e.g., amorphous manganese oxide), copper oxide, or both. Amorphous materials have little to no crystallinity, which contrasts with polymorphic materials. An example of an ozone destroying catalyst that includes amorphous manganese oxide is available from Carus LLC (Peru, IL) under the tradename CARULITE 400. In some embodiments, the active particles include a catalyst capable of ozone destruction that includes cerium dioxide. In some embodiments, the active particles include a catalyst capable of ozone destruction that includes manganese oxide, copper oxide, cerium dioxide, or any combination thereof.

In some embodiments, the active particles include a sorbent. In some embodiments, the sorbent is an adsorbent, an absorbent, or both. Examples of sorbents include cellulose, fumed silica, cotton, natural or synthetic sponge, clays, sodium polyacrylate, sodium alginate, gelatin, and wool.

In some embodiments, the active particles include an adsorbent such as a physisorbent, a chemisorbent, a physisorbent-chemisorbent hybrid, or any combination thereof. In some embodiments, the adsorbent is a chemisorbent-physisorbent hybrid. Chemisorbent-physisorbent hybrids include grafted hybrids and impregnated hybrids. A grafted hybrid is a chemisorbent grafted onto a physisorbent or a physisorbent grafted onto a chemisorbent. An impregnated hybrid is a physisorbent impregnated with a chemisorbent or a chemisorbent impregnated with a physisorbent. Grafted hybrids are characterized as a chemisorbent being covalently linked to the physisorbent. Impregnated hybrids are characterized as the chemisorbent being located within the pores of a physisorbent. In impregnated hybrids the chemisorbent is held in the pore via non-covalent interactions (e.g., van der Waals forces). In some embodiments, a graft hybrid or an impregnated hybrid includes one or more of the following physisorbents, activated carbon, a zeolite, a silicate, a metal-organic framework (MOFs), or a mesoporous transition metal oxide.

An adsorbent is a material that can adsorb a chemical; that is, the material can isolate a chemical on at least a portion of its surface area. A physisorbent is an adsorbent that isolates a chemical through the formation of weak interactions (e.g., van der Waals and/or electrostatic forces) between the physisorbent and the chemical being adsorbed. A chemisorbent is an adsorbent that isolates a chemical through the formation of an ionic or covalent bond between the chemisorbent and the chemical being adsorbed.

The identity of the adsorbent depends on the intended use of the composition. Adsorbents may be included that can adsorb a basic gas, an acidic gas, a gaseous organic compound, a gaseous inorganic compound, or combinations thereof. Such adsorbents may be a physisorbent, a chemisorbent, or a physisorbent-chemisorbent hybrid.

In some embodiments, the adsorbent can adsorb a gaseous organic compound. As used herein, the term “gaseous organic compound” refers to a compound that includes at least one carbon-hydrogen covalent bond and that is in the gas phase, vapor phase, or both. Examples of gaseous organic compounds that adsorbents can adsorb include aromatic hydrocarbons such as toluene, benzene, xylene, and ethylbenzene; polycyclic aromatic hydrocarbons such as the 16 polycyclic aromatic hydrocarbons classified as priority pollutants by the United States Environmental Protection Agency in 2005 (i.e., naphthalene, acenaphthylene, acenaphthene, fluorene, phenantbrene, anthracene, fluorantbene, pyrene, benz (a) anthracene, chrysene, benzo(b)fluoranthene, benzo (k) fluoranthene, benzo (a) fluoranthene, dibenz(a,h)anthracene, benzo(ghi)perylene, and indeno (1,2,3-cd) pyrene); n-alkanes such as methane, ethane, and n-propane, n-butane, n-pentane, and n-hexane; n-alkenes such as methylene, ethylene, propylene; various alcohols; aldehydes such as formaldehyde; siloxanes; or any combination thereof. Examples of adsorbents that can adsorb a gaseous organic compound include activated carbon, zeolites (e.g., zeolite X, zeolite A, zeolite Y, zeolite B. and zeolite ZSM-5), silicates, metal-organic frameworks (MOFs), mesoporous transition metal oxides, or any combination thereof.

In some embodiments, the active particles include an adsorbent that can adsorb a gaseous inorganic compound. As used herein, the term “gaseous inorganic compound” refers to a compound that does not have at least one carbon-hydrogen bond that is in the gas phase, vapor phase, or both. Examples of inorganic compounds that adsorbents can adsorb include carbon dioxide; carbon monoxide; water; perfluorocarbons such as tetrafluoromethane and hexafluoroethane; sulfur hexafluoride; ozone; or any combination thereof. Examples of adsorbents capable of adsorbing one or more inorganic compounds include activated carbon, zeolites (e.g., zeolite X, zeolite A, zeolite Y, zeolite B. and zeolite ZsM-5), silicates, metal-organic frameworks (MOFs), mesoporous transition metal oxides, or any combination thereof. Zeolite physisorbents are an example of an adsorbent capable of adsorbing ozone.

In some embodiments, the active particles include an adsorbent that can adsorb an acidic gas. An acidic gas is a gas that when mixed with water at a pH of 7, acidifies the water such that the pH of the resultant solution is below 7. Acidic gases may be gaseous inorganic compounds or gaseous organic compounds. Examples of acidic gases that adsorbents can adsorb include sulfur dioxide, nitrogen dioxide, hydrogen sulfide, sulfur trioxide, nitric oxide, or any combination thereof. Examples of adsorbents that can adsorb an acidic gas include chemisorbents that include a group I metal (Li, Na, K, Rb, Cs, Fr) carbonate; a metal oxide; a group I metal (Li, Na, K, Rb, Cs, Fr) hydroxide; a group II metal (Be, Mg, Ca, Sr, Ba, Ra) hydroxide; a group II metal (Bc, Mg, Ca, Sr, Ba, Ra) oxide; an N-containing compound such as an amine (e.g., tetraethylenepentamine, ethylenediamine and 3-aminopropyltriethoxysilane), an imine (e.g., polyethyleneimine), and an ammonium salt (e.g., ammonium persulfate); or any combination thereof. In some embodiments, the selected chemisorbent may be grafted onto a physisorbent, or impregnated within a physisorbent such as activated carbon; a zeolite; a silicate; or combinations thereof.

In some embodiments, the active particles include an adsorbent that can adsorb a basic gas. A basic gas is a gas that when mixed with water at a pH of 7, basifies the water such that the pH of the resultant solution is above 7. Basic gases may be gaseous inorganic compounds or gaseous organic compounds. Examples of basic gases that adsorbents can adsorb include ammonia and nitrogen trifluoride. Examples of adsorbents that can absorb a basic gas include physisorbents such as activated carbon, zeolites, silicates, or any combination thereof. Additional examples of adsorbents that can adsorb a basic gas include chemisorbents that have a carboxylic acid (COOH) functional group. Examples of chemisorbent compounds that have a carboxylic acid functional group include citric acid, terephthalic acid, trimesic acid, tartaric acid, maleic acid, benzoic acid, oxalic acid, or any combination thereof. Chemisorbents that can adsorb a basic gas include inorganic acids such as boric acid, nitric acid, sulfuric acid, hydrochloric acid, or any combination thereof. Such chemisorbents may be grafted onto or impregnated within a physisorbent such as activated carbon, a zeolite, a silicate, or combinations thereof.

In some embodiments, the active particles include a metal-organic framework (MOF). As used herein, the term “metal-organic framework (MOF)” refers to a compound that includes clusters of metal ions coordinated to organic ligands which form two- or three-dimensional structures. MOFs may be an adsorbent (e.g., physisorbent, chemisorbent, or both), a catalyst, or both. Examples of MOF adsorbents include copper benzene-1,3,5-tricarboxylate (C₁₈H₆Cu₃O₁₂, also known as HKUST-1, Cu-BTC MOF, or MOF-199; available from NOVOMOF in Zofingen, Aargau, Switzerland); zirconium 1,4-dicarboxyenzene MOF (Zr₆O₄(OH)₄ (dicarboxylate)₆, also known as UiO-66; available from NOVOMOF, Switzerland); zirconium 4,4′-biphenyldicarboxylic acid MOF (Zr₆O₄(OH)₄ (4,4′-biphenyldicarboxylic acid) 6, also known as UiO-67; available from NOVOMOF, Switzerland); or any combination thereof.

In some embodiments, the active particles include a growth seed. The growth seed may serve as the nucleation point for the synthesis of a metal-organic framework (MOF). In some such embodiments, the growth seed includes copper nitrate as a growth seed for a copper-based MOF such as copper benzene-1,3,5-tricarboxylate. In some embodiments, the growth seed includes trimesic acid as a growth seed for a copper-based MOF such as copper benzene-1,3,5-tricarboxylate. A growth seed may be reacted with one or more additional reagents prior to, during, or after matrix formation to from an MOF.

In some embodiments, the active particles include an electroactive material. In some embodiments, the electroactive material includes lithium. In some embodiments, the electroactive material includes lithium and one or more metals. Examples of cathode active electroactive material include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments, the cathode electroactive material is LiCoO₂. In some embodiments, the cathode active electroactive material is LiNiO₂.

In some embodiments, the electroactive material is an anode active compound species. Examples of anode electroactive material include Co₃O₄, Cu₂O, Li₄Ti₅O₁₂ (lithium titanate), SiO₂, FC₂O₃, Al₃Ni, CuCo₂O₄, PdNiBi, TiO, Sn₄P₃, NiO, carbides thereof, and any combination thereof. Examples of metallic anode materials include Li metal and alkaline earth metals such as Mg or Ca, as well as Si based compounds. The Si based compounds may be in the form of Si fibers. Further examples of anode electroactive species include LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof, and any combination thereof. The molecular formula of an anode electroactive material may not reflect the empirical formula. Additional examples of anode electroactive species include nitrides, oxides, carbides, of metallic or semi-metallic elements including Li, Co, Pd, Pt, W, Mo, Zr, Fe, Al, Ni, Ti, Sn, or any combination thereof. In some embodiments, the anode electroactive material is silicon. In some embodiments, the electroactive material is silicon, and the silicon is in silicon fiber configuration. In some embodiments, the anode electroactive material is Li₄Ti₅O₁₂.

Each particle of active particles has a particle size. The particle size is defined as the greatest cross-sectional distance across a particle. The average particle size of the plurality of active particles may vary based on the intended use of the tape or expanded tape and/or the chemical or physical properties of the active particles. The active particles may have an average particle size of 0.001 micrometer (micrometers) or greater, 0.01 micrometers or greater, 0.1 micrometers or greater, 1 micrometer or greater, 5 micrometers or greater, 10 micrometers or greater, or 100 micrometers or greater as measured according to the Dimensional Analysis Test Method. The plurality of active particles may have an average particle size of 500 micrometers or less, 100 micrometers or less, 10 micrometers or less, or 1 micrometer or less as measured according to the Dimensional Analysis Test Method.

Generally, smaller particle sizes may be preferred for particles that include catalysts due to their increased surface area and active site density available for catalyzing reactions. As such, in some embodiments where the plurality of active particles includes a catalyst, the average particle size of the plurality of active particles is 0.001 micrometers to 5 micrometers, 0.001 micrometers to 1 micrometer, or 0.001 micrometers to 0.1 micrometers as measured according to the Dimensional Analysis Test Method. Generally, active particles that include adsorbents with small particle sizes may be preferred as the smaller particle size may allow for larger surface area and greater diffusion. In some embodiments, where the plurality of active particles includes an adsorbent, the average particle size of the particles in the plurality of active particles is 0.001 micrometers to 100 micrometers, 1 micrometer to 100 micrometers, or 0.001 micrometers to 0.1 micrometers as measured according to the Dimensional Analysis Test Method.

The tapes and expanded tapes of the present disclosure may have a variety of active particle amounts. The weight-% of active particles (or any individual component of the active particles) in a tape or expanded tape may be calculated according to the Compositional Analysis Test Methods. The sum of the wt-% for each component of active particles is considered the wt-% of the active particles that include the components of the active particles in a tape or expanded tape. For example, if an active particle includes activated carbon, the amount of the activated carbon is the wt-% of the active particles that include the activated carbon. If a solid particulate includes manganese oxide and copper oxide, the wt-% of active particles that include the manganese oxide and copper oxide is the sum of the wt-% of manganese oxide and the wt-% of the copper oxide.

The total active particle amount is the sum of the wt-% of the one or more components making up the plurality of active particles in a tape or an expanded tape. For example, in embodiments where the active particles include manganese oxide and copper oxide, the total active particle wt-% in a tape or an expanded tape is the sum of the wt-% of the manganese oxide and the wt-% copper oxide. In some embodiments, the total active particle wt-% in the tape or expanded tape of the present disclosure is 50 wt-% or greater, 70 wt-% or greater, 80 wt-% or greater, or 90 wt-% or greater by weight of the tape or expanded tape, per the Compositional Analysis Test Method. In some embodiments, the total active particle wt-% in the tape or expanded tape of the present disclosure is 95 wt-% or less, 90 wt-% or less, 80 wt-% or less, or 70 wt-% or less by weight of the tape or expanded tape, per the Compositional Analysis Test Method.

For some end uses of a tape or expanded tape of the present disclosure such as a nanofiltration membrane, it may be beneficial to have low or no active particles in the tape or expanded tape. In some embodiments, the total active particle wt-% in the tape or expanded tape of the present disclosure is 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater. In some embodiments, the total active particle wt-% in the tape or expanded tape of the present disclosure is 20 wt-% of less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less.

In some embodiments, the tapes and expanded tapes of the present disclosure include one or more additives. An additive can function to enhance retention of the particle phase within the tape or the expanded tape. Additives may function to increase the processability of the fibrous matrix. For example, additives may function to increase the mechanical firmness of the fibrous matrix before and/or after processing; increase retention of the solvent mixture during processing of the fibrous matrix; improve the rheology and shape retention of the fibrous matrix during processing; or combinations thereof. Examples of additives include binders such as ceramic binders and polymer binders. Examples of binders include ceramic binders such as kaolinite, bentonite, silicon carbide, fumed silica, zeolites, and any combination thereof. In some embodiments the binder is a polymeric binder. Examples of polymeric binders include, polyamide (Nylon); polyamideimide (Torlon); polyacrylate; polyurethanes; styrene-butadiene rubber (SBR rubber); polyvinyl alcohol (PVA); polyvinyl chloride (PVC); silicone; polypropylene; polyethylene; aramid (Kevlar); polystyrene; poly(ethylene terephthalate) (PET), polyvinylidene fluoride (PVDF); polyvinyl acetate; polyacrylonitrile; already formed PTFE fibers, or any combination thereof. Other examples of polymeric binders include biopolymeric binders such as gelatin, methylcellulose, ethylcellulose, pectin, polyethylene glycol, sodium alginate, agar, xanthan gum, and any combination thereof. Another type of additive that may be included in a tape or expanded tape is inorganic fibers. The inclusion of inorganic fibers may enhance the chemical properties, electrical properties, thermal properties, or any combination thereof of the tape or expanded tape. Examples of inorganic fibers include carbon fiber, activated carbon fiber, metal fiber (e.g., steel fibers, cooper fibers, nickel fibers, and the like), ceramic fibers such as fiberglass, or any combination thereof.

In some embodiments, the tape or expanded tape includes 0.1 wt-% or greater, 1 wt-% or greater, 5 wt-% or greater, 10 wt-% or greater, or 15 wt-% or greater, 20 wt-% or greater, 25 wt-% or greater, 30 wt-% or greater 35 wt-% or great, 040 wt-% or greater, or 45 wt-% or greater total additives based on the total weight of the tape or expanded tape. In some embodiments, the tape or expanded tape includes 50 wt-% or less, 45 wt-% or less, 40 wt-% or less, 35 wt-% or less, 30 wt-% or less, 25 wt-% or less, 20 wt-% or less, 15 wt-% or less, 10 wt-% or less, 5 wt-% or less, or 1 wt-% or less of total additives based on the total weight of the tape or the expanded tape. In some embodiments, the tape or expanded tape includes 0.1 wt-% to 10 wt-%, 1 wt-% to 10 wt-% or 5 wt-% to 10 wt-% total additives based on the total weight of the tape or the expanded tape. For example, in some embodiments where the tape or expanded tape includes a polymeric binder additive, the tape or expanded tape can include 0.1 wt-% to 10 wt-%, 1 wt-% to 10 wt-% or 5 wt-% to 10 wt-% total additives based on the total weight of the tape or the expanded tape. In some embodiments, the tape or expanded tape includes 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the tape or the expanded tape. For example, in some embodiments where the tape or expanded tape includes a inorganic fiber additive, the tape or expanded tape can include 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the tape or the expanded tape.

The tapes and expanded tapes of the present disclosure are porous. The tapes and expanded tapes include a plurality of pores 75. A pore is a void space within a tape or expanded tape that is coupled to a major surface of the tape or expanded tape. A pore is defined by a pore surface formed from the material of the tape or expanded tape. Generally, the pore surface is not a major surface because the pore extends into the tape or expanded tape. Pores coupled to a major surface or a tape or expanded tape are accessible to fluid (i.e., liquid or gas) or solids present in the surrounding environment of the major surface. The plurality of pores may be through pores. A through pore is a pore that is coupled to (e.g., accessible from) one major surface by two or more pore openings, a first major surface and a second major surface by one or more pore openings, or both. A pore opening is the location where the pore interfaces with a major surface of the tape or expanded tape. Pores may have a variety of morphologies.

The tapes and expanded tapes of the present disclosure may include a variety of pore opening sizes. In some embodiments, the plurality of pores 75 have an average pore opening size of 10 micrometers or greater, 25 micrometers or greater, 50 micrometers or greater, 75 micrometers or greater, 100 micrometers or greater, 125 micrometers or greater, 150 micrometers or greater, 175 micrometers or greater, 200 micrometers or greater, 300 micrometers or greater, 400 micrometers or greater, or 500 micrometers or greater. In some embodiments, the plurality of pores 75 have an average pore opening size of 1000 micrometers or less 500 micrometers or less, 400 micrometers or less, 300 micrometers or less, 200 micrometers or less, 175 micrometers or less, 150 micrometers or less, 125 micrometers or less, 100 micrometers or less, 75 micrometers or less, 50 micrometers or less, or 25 micrometers or less.

The tapes and expanded tapes of the present disclosure may include a variety of permeabilities as measured according to the Permeability Test Method. In some embodiments, the permeability of a tape or expanded tape is 2 cubic feet per minute (cfm) (0.057 cubic meter per minute (cmm)) or greater, 3 cfm (0.085 cmm) or greater, 4 cfm (0.11 cmm) or greater, 5 cfm (0.14 cmm) or greater, 6 cfm (0.17 cmm) or greater, 7 cfm (0.2 cmm) or greater, 8 cfm (0.23 cmm) or greater, 9 cfm (0.26 cmm) or greater, 10 cfm (0.29 cmm) or greater, 11 cfm (0.31 cmm) or greater, 12 cfm (0.34 cmm) or greater, 13 cfm (0.37 cmm) or greater, 14 cfm (0.4 cmm) or greater, 15 cfm (0.43 cmm) or greater, 20 cfm (0.57 cmm) or greater, 25 cfm (0.71 cmm) or greater, or 30 cfm (0.86 cmm) or greater. In some embodiments, the permeability of a tape or expanded tape is 50 cfm (1.43 cmm) or less, 30 cfm (0.86 cmm) or less, 25 cfm (0.71 cmm) or less, 20 cfm (0.57 cmm) or less, 15 cfm (0.43 cmm) or less, 14 cfm (0.4 cmm) or less, 13 cfm (0.37 cmm) or less, 12 cfm (0.34 cmm) or less, 11 cfm (0.31 cmm) or less, 10 cfm (0.29 cmm) or less, 9 cfm (0.26 cmm) or less, 8 cfm (0.23 cmm) or less, 7 cfm (0.2 cmm) or less, 6 cfm (0.17 cmm) or less, 5 cfm (0.14 cmm) or less, 4 cfm (0.11 cmm) or less, or 3 cfm (0.085 cmm) or less.

The density of the plurality of pores of the tapes and expanded tapes of the present disclosure may vary. The density of pores can be denoted as the number of pores per square cm (cm²) of the tape or expanded tape. In some embodiments, density of pores in a tape or expanded tape is 1 pore per square cm or more, 5 pores per square cm or more, 10 pores per square cm or more, 25 pores per square cm or more, 50 pores per square cm or more, 75 pores per square cm or more, 100 pores per square cm or more, 150 pores per square cm or more, 200 pores per square cm or more, 300 pores per square cm or more, 400 pores per square cm or more, or 500 pores per square cm or more. In some embodiments, density of pores in a tape or expanded tape is 1000 pores per square cm or less, 500 pores per square cm or less, 400 pores per square cm or less, 300 pores per square cm or less, 200 pores per square cm or less, 150 pores per square cm or less, 100 pores per square cm or less, 75 pores per square cm or less, 50 pores per square cm or less, 25 pores per square cm or less, 10 pores per square cm or less, or 5 pores per square cm or less.

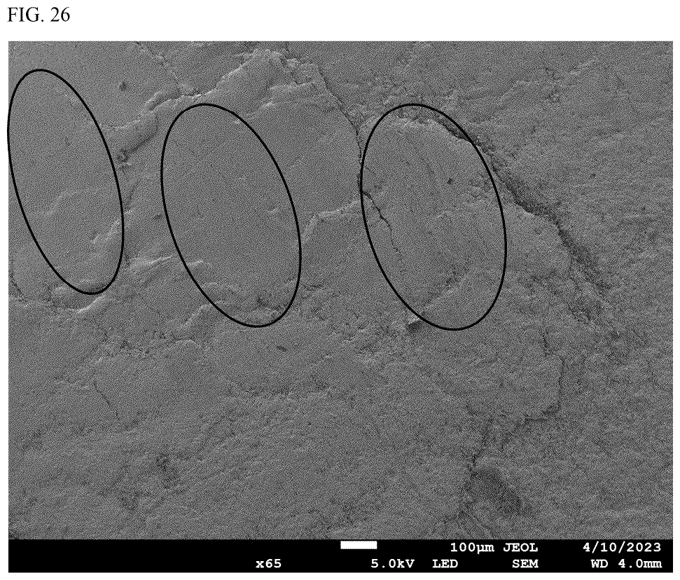

Returning to FIG. 1, a tape 10 includes or is a machined matrix 20. The machined matrix has a machined direction. The machined direction is the direction of the force applied to the fibrous matrix to produce the machined matrix. A machined matrix is formed from a fibrous matrix. A fibrous matrix is a malleable material that includes short-strand PTFE fibrils, long-strand PTFE fibrils, and active particles. A machined matrix is formed by flattening and/or machining the fibrous matrix to form a tape. A machined matrix 20 includes long-strand PTFE fibrils. The long-strand PTFE fibrils form an oriented network 30. The long-strand PTFE fibrils define a longitudinal direction 60. The oriented network 30 includes at least a portion of the long-strand PTFE fibrils 22. FIG. 26 is a scanning electron micrograph of a machined matrix showing the orientation of the long-strand PTFE fibrils along a longitudinal direction.

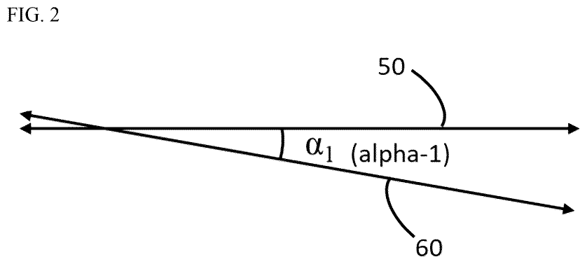

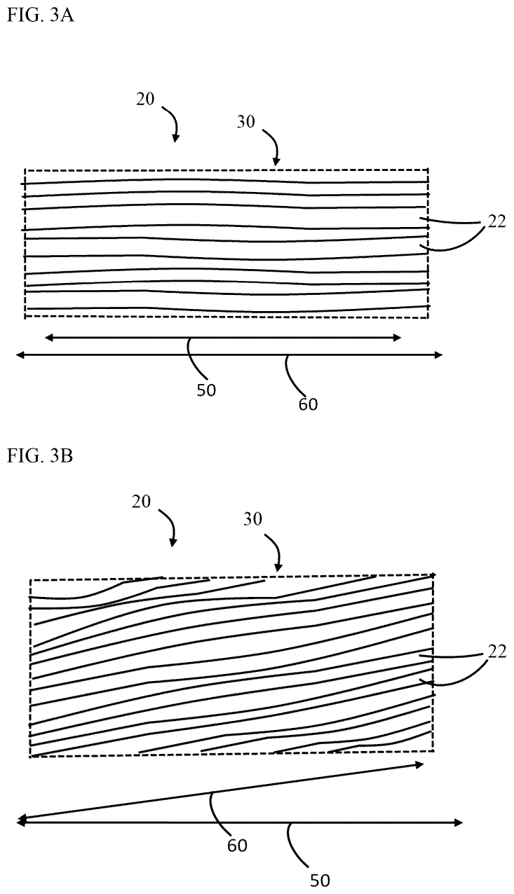

FIGS. 1, 2 and 3A-3B illustrate the relationship between the oriented network 30 of long-strand PTFE fibrils 22, the longitudinal direction 60, and the machined direction 50. The long-strand PTFE fibrils 22 define a longitudinal direction 60 (FIG. 1). The longitudinal direction 60 and the machined direction 50 define an angle alpha-1 (α₁) (FIG. 3A-3B). In some embodiments, ai can be 0 degrees or greater, 5 degrees or greater, 10 degrees or greater, 15 degrees or greater, 20 degrees or greater, 25 degrees or greater, 30 degrees or greater, 50 degrees or greater, or 75 degrees or greater. In some embodiments, alpha-1 can be 90 degrees or less, 75 degrees or less, 50 degrees or less, 30 degrees or less, 25 degrees or less, 20 degrees or less, 15 degrees or less, 10 degrees or less, or 5 degrees or less. In some embodiments, alpha-1 is 0°. When alpha-1 is 0°, the longitudinal direction 60 and the machined direction 50 are the same.

FIGS. 3A and 3B show a portion of a machined matrix 20 of a tape (nodes not shown) where alpha-1 is 0 degrees (FIG. 3A) and greater than 0 degrees (FIG. 3B). The machined matrix 20 includes an oriented network 30 of long-strand PTFE fibrils 22. The long-strand PTFE fibrils 22 define a longitudinal direction 60. The machined matrix has a machined direction 50. In FIG. 3A, the longitudinal direction 60 and the machined direction 50 define an alpha-1 of 0 degrees; that is, the longitudinal direction 60 and the machined direction 50 are the same. In FIG. 3B, the longitudinal direction 60 and the machined direction 50 define an alpha-1 that is greater than 0 degrees; that is, the longitudinal direction 60 and the machined direction 50 are not the same.

In some embodiments, the long-strand PTFE 22 fibrils are substantially oriented along the machined direction 50 of the machined matrix 20. In some such embodiments, 60% or greater, 70% or greater, 80% or greater, 90% or greater, or 95% or greater for the long-strand PTFE fibrils are oriented at an alpha-1 of 20 degrees or less. In some embodiments 60% or greater, 70% or greater, 80% or greater, 90% or greater, or 95% or greater of the long-strand PTFE fibrils are oriented at an alpha-1 of 10 degrees or less. In some embodiments 60% or greater, 70% or greater, 80% or greater, 90% or greater, or 95% or greater of the long-strand PTFE fibrils are oriented at an alpha-1 of 5 degrees or less. In some embodiments 60% or greater, 70% or greater, 80% or greater, 90% or greater, or 95% or greater of the long-strand PTFE fibrils are oriented at an alpha-1 of 1 degree or less. The percentage of PTFE fibrils oriented at a particular alpha-1 can be calculated according to the Dimensional Analysis Test Method.

Returning to FIG. 1, the machined matrix includes nodes 40. The nodes 40 may be distributed among the oriented network 30. The nodes 40 may be evenly distributed among the oriented network 30. The nodes 40 may be distributed unevenly among the oriented network 30. For example, there may be portions of the oriented network 30 that have a higher concentration of nodes than other portions of the oriented network 30. The nodes 40 include short-strand PTFE fibrils 32 and active particles 42. The active particles 42 may be distributed among the short-strand PTFE fibrils 24. Some active particles 42 may be present in locations of the machined matrix 20 other than the nodes 40.

The active particles 42 contact and/or interact with the long-strand PTFE fibrils 22, the short-strand PTFE fibrils 24, or both (FIG. 1, box 70). Active particles 42 that are interacting with other active particles 42, the long-strand PTFE fibrils 22, the short-strand PTFE fibrils 24, or combinations thereof are physically and/or chemically immobilized in the machined matrix. That is, the term “interaction” refers to a physical force (e.g., frictional force, gravitational force, compression force, tensile force, electrical force, magnetic force, spring force, applied force, or normal force) or a chemical force (e.g., Van der Waals force, Debey force, Keesom force, London dispersion force, dipole-dipole force, or hydrogen bonding) between two or more active particles, an active particle and a short-strand PTFE fibril (or multiple short-strand PTFE fibrils), an active particle and a long-strand PTFE fibril (or multiple long-strand PTFE fibrils), or combinations thereof.

The active particles 42 may have one or more configurations in which they interact with the short-strand PTFE fibrils 24, the long-strand PTFE fibrils 22, or both. In some embodiments, at least a portion of the active particles and at least a portion of the PTFE fibrils adopt a catenated structure, a conglomerated structure, or both. In some embodiments, at least a portion of the active particles 42 form a catenated structure around one or more short-strand PTFE fibrils 24, one or more long-strand PTFE fibrils 22, or both; at least a portion of the active particles 42 form a conglomerated structure with the one or more short-strand PTFE fibrils 24, one or more long-strand-PTFE fibrils 22, or both; or a combination thereof.

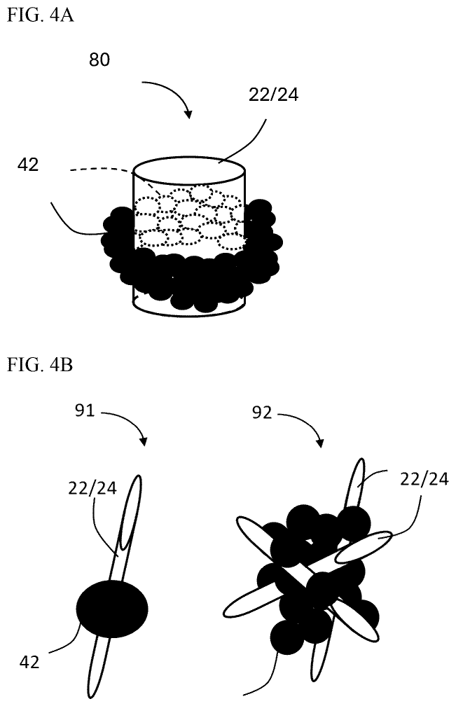

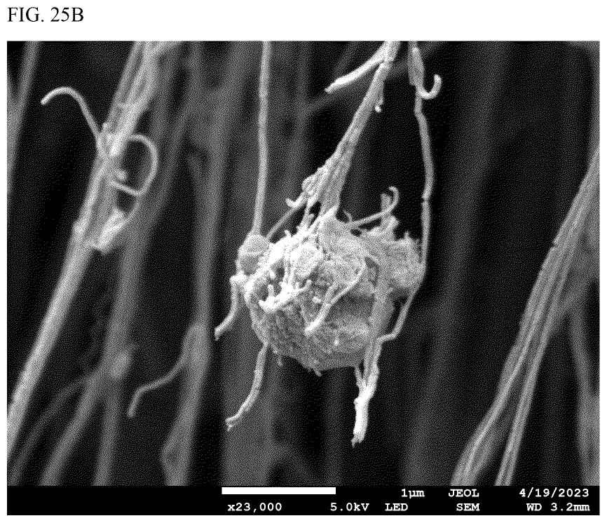

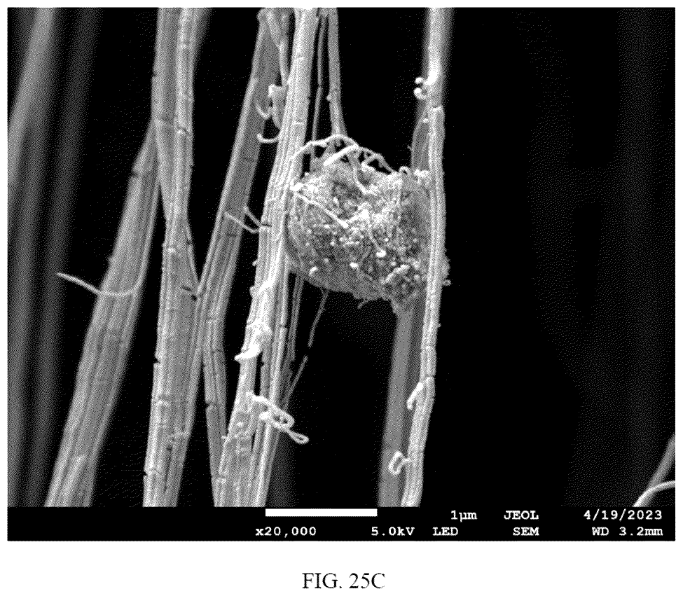

A catenated structure is a self-supporting network of active particles 42 that encapsulates at least a portion of one or more PTFE fibrils. FIG. 4A is a schematic representation of a catenated structure 80. In a catenated structure, active particles 42 form a self-supporting network that encapsulates at least a portion of one or more PTFE fibrils 22/24 (e.g., one or more long-strand PTFE fibrils, one or more short-strand PTFE fibrils, or both). While the self-supporting network may be contacting and/or interacting with the one or more PTFE fibrils that it at least partially encapsulates, the primary interaction holding the catenated structure together is the physical interaction between adjacent particles. Without wishing to be bound by theory, it is thought that if the at least partially encapsulated (or entirely encapsulated) PTFE fibril could be removed, the self-supporting network of particles would remain undisturbed. Individual active particles that are involved in a catenated structure may not be well defined because the active particles may merge into one another to create the self-supporting network. FIG. 25A is a scanning electron micrograph showing a catenated structure in an expanded matrix.

The self-supporting network of active particles can encapsulate a portion of a single PTFE fibril, a portion of multiple PTFE fibrils, an entire PTFE fibril, or the entirety of multiple PTFE fibrils in a catenated structure. The self-supporting network of active particles may encapsulate at least a portion of one or more short-strand PTFE fibrils, at least a portion of one or more long-strand PTFE fibrils, or both in a catenated structure. It is generally thought that catenated structures primarily include the encapsulation of at least a portion of one or more short-strand PTFE fibrils.

Without wishing to be bound by theory, it is thought catenated structures may reduce the likelihood of particle shedding from the machined matrix. Additionally, it is thought that active particles adopting a catenated structure may have a large, exposed surface area due to their spacing and number of exposed faces. This property may increase their activity as catalysts, adsorbents, growth seeds, MOFs, or any combination thereof by way of enhancing active site accessibility and diffusional rates through the porous microstructural body.

A conglomerated structure is an active particle or an aggregate of active particles that is at least partially held together by one or more PTFE fibrils (e.g., short-strand PTFE fibrils or long-strand PTFE fibrils). In contrast to a catenated structure, the particles of a conglomerated structure do not form a self-supporting network that is generally independent of the PTFE fibrils. In a conglomerated structure, an active particle or aggregate of active particles are held in place through an interaction with one or more PTFE fibrils (e.g., short-strand PTFE fibrils) that extend through (e.g., run through) the particle or aggregate. An aggregate of active particles is a cluster of two or more active particles, each active particle interacting with at least one other active particle of the cluster. In a conglomerated structure that includes an aggregate, the aggregate is held together both through interactions between active particles and interactions between active particles and PTFE fibrils. In contrast to a catenated structure, the active particles of conglomerated structures are generally well defined.

FIG. 4B is a schematic representation of two conglomerated structures 91 and 92 that are consistent with embodiments of the present disclosure. Conglomerated structure 91 is a PTFE fibril 22/24 (short-strand PTFE fibril or long-strand PTFE fibril) running through (i.e., interacting with) a single active particle 42. Conglomerated structure 92 is several PTFE fibrils 22/24 running through (i.e., interacting with) an aggregate that includes active particles 42. FIG. 25B and FIG. 25C are scanning electron micrographs of conglomerated structures.

Without wishing to be bound by theory, it is thought that conglomerated structures may impart some degree of mechanical stability to at least a portion of the active particles, at least a portion of the PTFE fibrils (e.g., long-strand PTFE fibrils, short-strand PTFE fibrils, or both), or both. For example, it is thought that a conglomerated structure may at least partially inhibit one or more of the PTFE fibrils participating in the conglomerated structure from contracting (i.e., decreasing in length). Additionally, conglomerated structures are thought to reduce the likelihood of particle shedding due to the strength imparted by the PTFE fibrils with which the particles of a conglomerated structure are interacting.

The present disclosure describes a tape having a first machined direction and a second machined direction. The tape includes or is a machined matrix. The machined matrix has long-strand PTFE fibrils and nodes. The long-strand PTFE fibrils form an oriented network. The nodes are distributed among the oriented network. The nodes generally have active particles and short-strand PTFE distributed among the active particles. In some embodiments, the oriented network includes a first portion of the long-strand PTFE fibrils and a second portion of the long-strand PTFE fibrils. The first portion of the long-strand PTFE fibrils defines a first longitudinal direction. The second portion of the long-strand PTFE fibrils defines a second longitudinal direction. In some embodiments, the first longitudinal direction and the second longitudinal direction are the same. In other embodiments, the first longitudinal direction and the second longitudinal direction are different.

The first longitudinal direction and the first machined direction of the machined matrix define a first angle alpha-10 (α₁₀) of 0 degrees to 90°. In some embodiments, the first portion of long-strand PTFE fibrils are substantially oriented along the first machined direction of the machined matrix. In some such embodiments, 60% or greater, 70% or greater, 80% or greater, 90% or greater, or 95% or greater of the first portion of the long-strand PTFE fibrils are oriented at an alpha-10 of 20 degrees or less. In some embodiments 60% or greater, 70% or greater, 80% or greater, 90% or greater, or 95% or greater of the first portion of long-strand PTFE fibrils are oriented at an alpha-10 of 10 degrees or less. In some embodiments 60% or greater, 70% or greater, 80% or greater, 90% or greater, or 95% or greater of the first portion of long-strand PTFE fibrils are oriented at an alpha-10 of 5 degrees or less. In some embodiments, 60% or greater, 70% or greater, 80% or greater, 90% or greater, or 95% or greater of the first portion of long-strand PTFE fibrils are oriented at an alpha-10 of 1 degree or less. The percent of PTFE fibrils oriented at a particular alpha-10 can be calculated according to the Dimensional Analysis Test Method.

The second longitudinal direction and the second machined direction of the machined matrix define second angle alpha-11 (α₁₁) of 0 degrees to 90 degrees. In some embodiments, the second portion of long-strand PTFE fibrils are substantially oriented along the second machined direction of the machined matrix. In some such embodiments, 60% or greater, 70% or greater, 80% or greater, 90% or greater, or 95% or greater of the second portion of the long-strand PTFE fibrils are oriented at an alpha-11 of 20 degrees or less. In some embodiments 60% or greater, 70% or greater, 80% or greater, 90% or greater, or 95% or greater of the second portion of long-strand PTFE fibrils are oriented at an alpha-11 of 10 degrees or less. In some embodiments 60% or greater, 70% or greater, 80% or greater, 90% or greater, or 95% or greater of the second portion of the long-strand PTFE fibrils are oriented at an alpha-11 of 5 degrees or less. In some embodiments 60% or greater, 70% or greater, 80% or greater, 90% or greater, or 95% or greater of the second portion of the long-strand PTFE fibrils are oriented at an alpha-11 of 1 degree or less. The percentage of PTFE fibrils oriented at a particular alpha-11 can be calculated according to the Dimensional Analysis Test Method.

The first longitudinal direction and the second longitudinal direction define an alpha-12 (α₁₂) that is 0 degrees to 90 degrees. In some embodiments, alpha-12 can be 0 degrees or greater, 5 degrees or greater, 10 degrees or greater, 15 degrees or greater, 20 degrees or greater, 25 degrees or greater, 30 degrees or greater, 50 degrees or greater, or 75 degrees or greater. In some embodiments, alpha-12 can be 90 degrees or less, 75 degrees or less, 50 degrees or less, 30 degrees or less, 25 degrees or less, 20 degrees or less, 15 degrees or less, 10 degrees or less, or 5 degrees or less. In some embodiments, alpha-12 is 0 degrees. When alpha-12 is 0 degrees, the first longitudinal direction and second longitudinal direction are the same.

The first machined direction and second machined direction define an angle alpha-3 (α₃). In some embodiments, alpha-3 can be 0 degrees or greater, 5 degrees or greater, 10 degrees or greater, 15 degrees or greater, 20 degrees or greater, 25 degrees or greater, 30 degrees or greater, 50 degrees or greater, or 75 degrees or greater. In some embodiments, α₁ can be 90 degrees or less, 75 degrees or less, 50 degrees or less, 30 degrees or less, 25 degrees or less, 20 degrees or less, 15 degrees or less, 10 degrees or less, or 5 degrees or less. In some embodiments, alpha-3 is 0 degrees. When alpha-3 is 0 degrees, the first machined direction and second machine direction are the same. When alpha-3 is about 90 degrees, the machined matrix was cross machined.

In some embodiments, 50% or greater of the first portion of the long-strand PTFE fibrils are oriented at the first angle alpha-10 (α₁₀). In some embodiments, 50% or greater of the second portion of the long-strand PTFE fibrils are oriented at the second angle alpha-11 (α₁₁). In some embodiments, 50% or greater of the first portion of the long-strand PTFE fibrils are oriented at the first angle alpha-10 and 50% or greater of the second portion of the long-strand PTFE fibrils are oriented at the second angle alpha-11.

In some embodiments, the first longitudinal direction and the second longitudinal direction are the same. In some such embodiments, 50% or greater, 60% or greater, 70% or greater, 80% or greater, or 90% or greater of the total long-strand PTFE fibrils (first portion and second portion of long-strand PTFE fibrils) define a longitudinal direction that is 30% to 70% or 40% to 60% of α₃. For example, if alpha-3 is 90 degrees, 50% or greater, 60% or greater, 70% or greater, 80% or greater, or 90% or greater of the total long-strand PTFE fibrils may be oriented at an angle between 27 degrees to 63 degrees or 36 degrees to 54 degrees.

Tapes of the present disclosure may have a variety of average thicknesses. In some embodiments, a tape has an average thickness of 0.2 centimeters (cm) or greater, 0.3 cm or greater, 0.4 cm or greater, 0.5 cm or greater, 0.6 cm or greater, 0.7 cm or greater, 0.8 cm or greater, or 0.9 cm or greater. In some embodiments, a tape has an average thickness of 1 cm or less, 0.9 cm or less, 0.8 cm or less, 0.7 cm or less, 0.6 cm or less, 0.5 cm or less, 0.4 cm or less, or 0.3 cm or less.

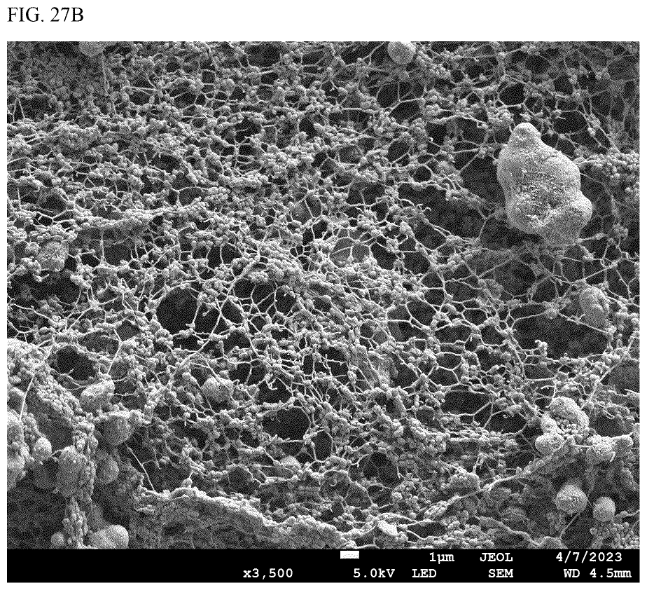

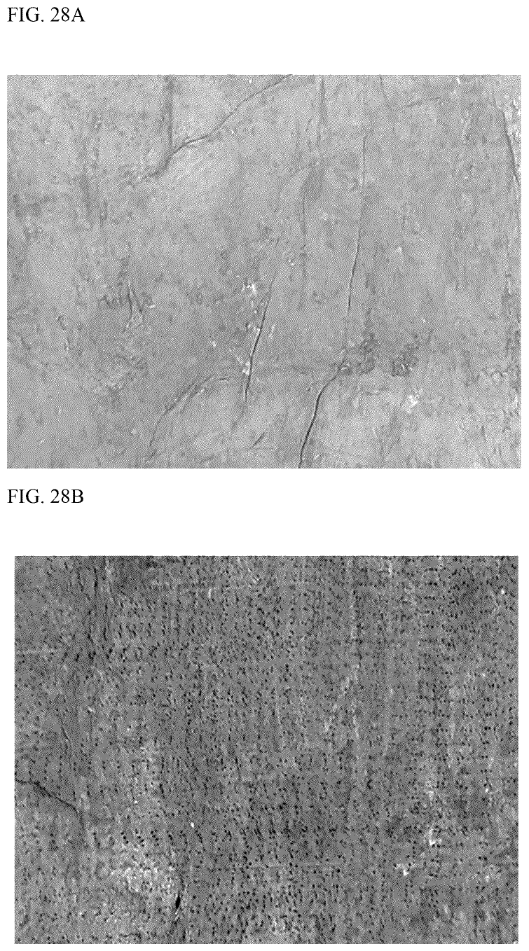

Returning to FIG. 1, the tape and/or machined matrix includes a plurality of pores 75. The plurality of pores 75 may be through pores. The density of the pores in the plurality of pores may be uniform throughout the tape. The density of the pores in the plurality of pores may vary throughout the tape. For example, the tape may have a first area of first pore density and an area of second pore density. The plurality of pores may have a pore density as described herein. The pore openings of the plurality of pores may vary. The plurality of pores may have an average pore opening size as described herein. In some embodiments, the tape and/or matrix may have two pluralities of pores, each plurality having a different pore opening size and/or a different pore density. FIG. 28A and FIG. 28B show a major surface of a machined matrix that does not include a plurality of prose (FIG. 28A) and a machined matrix that does include a plurality of pores.

The oriented network 30 may be disrupted or deformed on a pore surface and/or proximate to a pore. For example, in or near a pore, the long-strand PTFE fibrils may be oriented in a direction that is different than the longitudinal direction. For example, the oriented network may extend into the pore along the pore surface such that the long-strand PTFE fibrils at and/or proximate to the pore opening are oriented at a first direction and the long-strand PTFEs along the pore surface are oriented at a second direction.

Without wishing to be bound by theory, it is thought that the plurality of pores in a tape or expanded tape make active particles located deep between the two major surfaces of the tape accessible to gas or liquid. Increased accessibility may increase the efficiency and/or effectiveness of the active particles.

The present disclosure describes expanded tapes. An expanded tape of the present disclosure may be formed by subjecting a tape of the present disclosure to expansion using methods such as those described herein.

FIG. 5 is a schematic of an expanded tape 100. The expanded tape 100 includes or is an expanded matrix 200. The expanded matrix 200 has an expanded direction 90. An expanded matrix 200 may be formed by expanding a machined matrix 20 or a tape 10 of the present disclosure. An expanded matrix 200 includes long-strand PTFE fibrils 22. The long-strand PTFE fibrils 22 form an oriented network 30. The oriented network 30 of the expanded matrix 200 may have the same general orientation as the oriented network 30 of the machined matrix 20 from which it was formed. The oriented network 30 includes at least a portion of the long-strand PTFE fibrils 22 oriented along the expanded direction 90 of the expanded matrix 200. The expanded direction 90 is the direction that the machined matrix is expanded in.

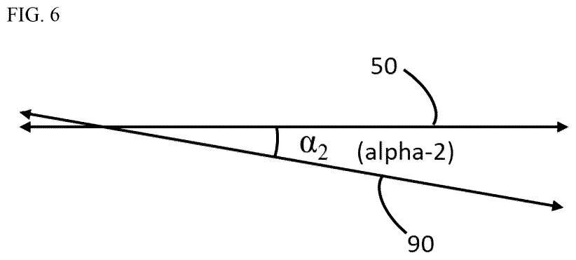

FIGS. 5, 6 and 7A-7B illustrate the relationship between the oriented network 30 of long-strand PTFE fibrils 22 and the expanded direction 90. As discussed in reference to the machined matrix, the long-strand PTFE fibrils 22 define a longitudinal direction 60 (FIG. 5). The longitudinal direction is defined at least in part by the machined direction (50 in FIGS. 1, 2, 3A, and 3B). The longitudinal direction 60 and the expanded direction 90 define an angle alpha-2 (FIG. 6). In some embodiments, the longitudinal direction 60 and the machined direction 50 are the same (alpha-1=0 degrees). In such embodiments, the machined direction 50 and the expanded direction 90 define alpha-2. In some embodiments, alpha-2 can be 0 degrees or greater, 5 degrees or greater, 10 degrees or greater, 15 degrees or greater, 20 degrees or greater, 25 degrees or greater, 30 degrees or greater, 50 degrees or greater, or 75 degrees or greater. In some embodiments, alpha-2 can be 90 degrees or less, 75 degrees or less, 75 degrees or greater, 50 degrees or less, 30 degrees or less, 25 degrees or less, 20 degrees or less, 15 degrees or less, or 10 degrees or less, or 5 degrees or less. In some embodiments, alpha-2 is 0 degrees. When alpha-1 is 0 degrees, the longitudinal direction 60 and the expanded direction 90 are the same. In embodiments, when alpha-1 and alpha-2 are 0 degrees, the machined direction 50 and the expanded direction 90 are the same.

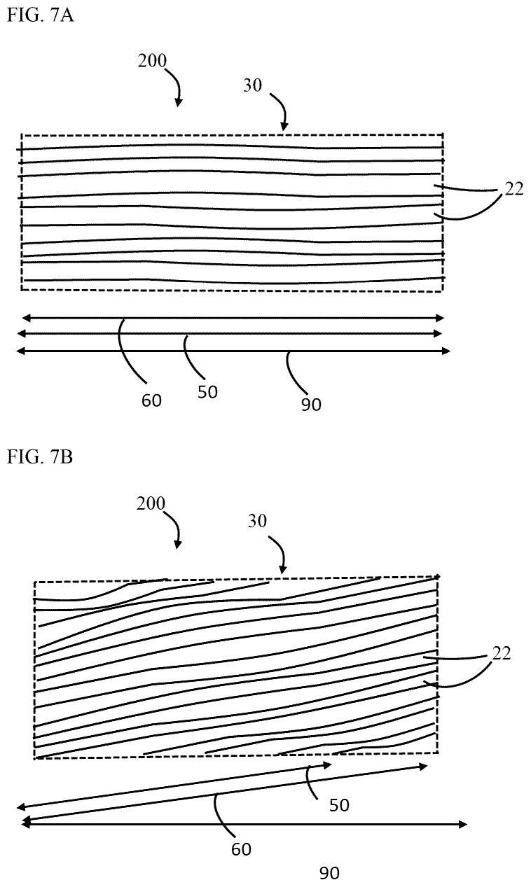

FIG. 7A shows a portion of an expanded matrix 200 of an expanded tape 100 (nodes not shown) where alpha-2 is 0 degrees. The expanded matrix 200 includes an oriented network 30 of long-strand PTFE fibrils 22. The long-strand PTFE fibrils 22 define a longitudinal direction 60. The expanded matrix 200 has a machined direction 50 and an expanded direction 90. The longitudinal direction 60 and the expanded direction 90 define an alpha-2 of 0 degrees; that is, the longitudinal direction 60 and the expanded direction 90 are the same. Additionally, the expanded matrix was formed from a machined matrix where the long-strand PTFE fibrils 22 were substantially oriented along the machined direction. Stated differently, 60% or greater, 70% or greater, 80% or greater, 90% or greater, or 95% or greater of the long-strand PTFE fibrils are oriented at an alpha-1 (the angle defined by the longitudinal direction 60 and the machined direction 50) of 20 degrees or less (e.g., 0 degrees to 1 degree or 0 degrees to 5 degrees). Therefore, the longitudinal direction 60, the machined direction 50, and the expanded direction 90 are essentially the same.

FIG. 7A shows a portion of an expanded matrix 200 of an expanded tape 100 (nodes not shown) where alpha-2 is greater than 0 degrees. The expanded matrix 200 includes an oriented network 30 of long-strand PTFE fibrils 22. The long-strand PTFE fibrils 22 define a longitudinal direction 60. The expanded matrix 200 has a machined direction 50 and an expanded direction 90. The longitudinal direction 60 and the expanded direction 90 define an alpha-2 that is greater than 0 degrees; that is, the longitudinal direction 60 and the expanded direction 90 are not the same. The expanded matrix was formed from a machined matrix where the long-strand PTFE fibrils 22 were substantially oriented along the machined direction 50. Stated differently, 60% or greater, 70% or greater, 80% or greater, 90% or greater, or 95% or greater of the long-strand PTFE fibrils are oriented at an alpha-1 (the angle defined by the longitudinal direction 60 and the machined direction 50) of 20 degrees or less (e.g., 0 degrees to 1 degree or 0 degrees to 5 degrees). In FIG. 7A, the longitudinal direction 60 and the machined direction 50 are essentially the same (alpha-1 is about 0 degrees), but the expanded direction 90 is different (alpha-2 is greater than 0 degrees).

In some embodiments, the long-strand PTFE fibrils are substantially oriented along the expanded direction 90 of the expanded matrix 200. In some such embodiments 60% or greater, 70% or greater, 80% or greater, 90% or greater, or 95% or greater of the long-strand PTFE fibrils are oriented at an alpha-2 of 20 degrees or less. In some embodiments 60% or greater, 70% or greater, 80% or greater, 90% or greater, or 95% or greater for the long-strand PTFE fibrils are oriented at an alpha-2 of 10 degrees or less. In some embodiments 60% or greater, 70% or greater, 80% or greater, 90% or greater, or 95% or greater of the long-strand PTFE fibrils are oriented at an alpha-2 of 5 degrees or less.

Returning to FIG. 5, the expanded matrix includes nodes 40. The nodes 40 may be distributed among the oriented network 30. The nodes 40 may be evenly distributed among the oriented network 30. The nodes 40 may be distributed unevenly among the oriented network 30. For example, there may be portions of the oriented network with a higher concentration of nodes than other portions. The distance between two or more nodes 40 may be greater in the expanded matrix 200 (FIG. 5) than the distance between the same two or more nodes 40 in the machined matrix 20 from which it was formed (FIG. 1). A node 40 in an expanded matrix 200 may have increased in size (surface area) as compared to the same node in the machined matrix 20 (FIG. 1).

The nodes 40 include short-strand PTFE fibrils 32 and active particles 42. The active particles 42 may be distributed among the short-strand PTFE fibrils 24. Some active particles 42 may be present in locations of on the expanded matrix 200 other than the nodes 40. The active particles 42 contact and/or interact with the long-strand PTFE fibrils 22, the short-strand PTFE fibrils 24, or both (FIG. 5, box 70). For a given node, the active particles 42 of an expanded matrix 200 may be less densely packed than the active particles 42 in the same node of a machined matrix 20. Without wishing to be bound by theory, it is thought that the accessible surface area of the active particles in the expanded matrix is greater than that of the accessible surface area of the active particles in the machined matrix.

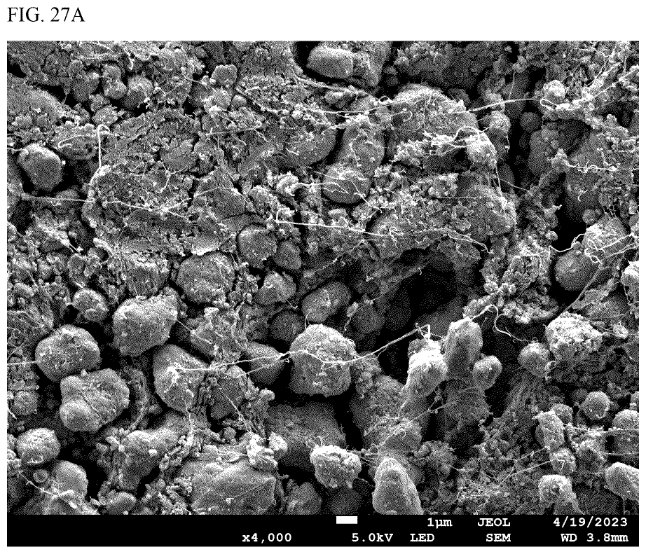

FIGS. 27A and 27B are scanning electron micrographs of a machined matrix (27A) and an expanded matrix (FIG. 27B) formed from the machined matrix. The machined matrix and the expanded matrix had 72.7 wt-% active particle loading. The images show one or more nodes. In comparison to the machined matrix, there is more space between the active particles of the expanded matrix. Additionally, the active particles of the expanded matrix are smaller than those of the machined matrix. The greater distance between the active particles and the smaller active particles contribute to an increased accessible active particle surface area, which is theorized to enhance active site accessibility to give rise to improved catalyst activity.

The active particles 42 contact and/or interact with the long-strand PTFE fibrils 22, the short-strand PTFE fibrils 24, or both (FIG. 5, box 70). Active particles 42 that are interacting with other active particles 42, the long-strand PTFE fibrils 22, the short-strand PTFE fibrils 24, or combinations thereof are physically and/or chemically immobilized in the machined matrix. The active particles may adopt a catenated structure, a conglomerated structure, or both.

Returning to FIG. 5, the expanded tape includes a plurality of pores 75. The plurality of pores 75 may be through pores. The density of the pores in the plurality of pores may be uniform throughout the tape. The density of the pores in the plurality of pores may vary throughout the tape. For example, the tape may have a first area of first pore density and an area of second pore density. The plurality of pores may have a pore density as described herein. The pore openings of the plurality of pores may vary. The plurality of pores may have an average pore opening size as described herein. In some embodiments, the tape and/or matrix may have two pluralities of pores, each plurality having a different pore opening size and/or a different pore density.

The oriented network 30 may be disrupted or deformed on a pore surface and/or proximate to a pore. For example, in or near a pore, the long-strand PTFE fibrils may be oriented in a direction that is different than the longitudinal direction. For example, the oriented network may extend into the pore along the pore surface such that the long-strand PTFE fibrils at and/or proximate to the pore opening are oriented at a first direction and the long-strand PTFEs along the pore surface are oriented at a second direction.

Expanded tapes of the present disclosure may have a variety of average thicknesses. In some embodiments, an expanded tape has an average thickness of 10 micrometers or greater, 50 micrometers or greater, 70 micrometers or greater, 100 micrometers or greater, 500 micrometers or greater, 700 micrometers or greater, 1000 micrometers or greater, or 2000 micrometers or greater. In some embodiments, an expanded tape has an average thickness of 2500 micrometers or less, 2000 micrometers or less, 1000 micrometers or less, 700 micrometers or less, 500 micrometers or less, 100 micrometers or less, 70 micrometers or less, or 50 micrometers or less. The average thickness of an expanded tape may be at least partially dependent on the desired use for the expanded tape. In some embodiments, thinner expanded tapes may allow for a greater accessible surface area of the active particles.

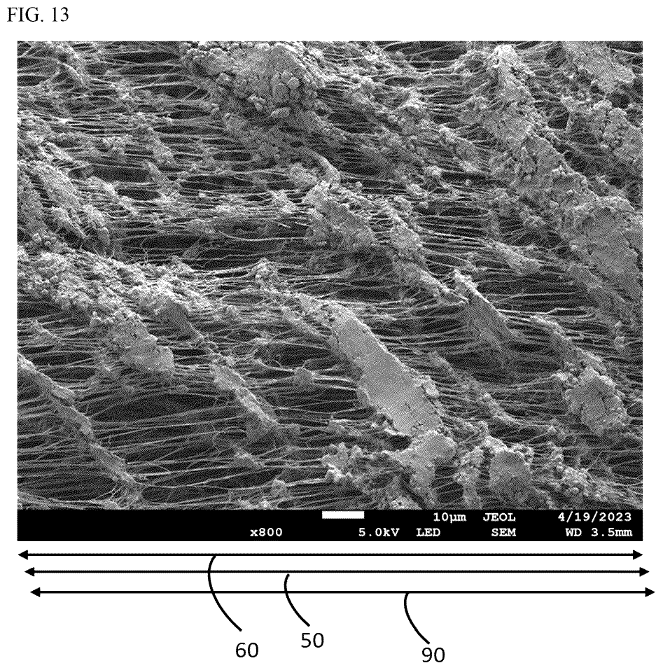

FIG. 13 is a scanning electron micrograph of an expanded tape that includes CARULITE active particles (available from Carus, Peru, IL). In the SEM image, the oriented network is visible including the long-strand PTFE fibrils and the nodes distributed within the oriented network. The expanded tape was formed by machining a fibrous matrix using the methods of the present disclosure to form a machined matrix where the long-strand PTFE fibrils were substantially oriented along the machined direction 50; that is, the longitudinal direction 60 defined by the long-strand PTFE is the same as the machined direction 50 (alpha-1 is about 0 degrees). The machined matrix was then expanded in an expanded direction 90. The expanded direction and the machined direction were the same. As such the PTFE-fibrils are substantially oriented along the expanded direction 90 and the machined direction 50.

Some of the expanded tape of the present disclosure has unique structural properties. Compared to the network of PTFE fibrils in conventional expanded PTFE (FIG. 14), some of the expanded tapes of the PTFE fibrils of the present disclosure are substantially oriented along a singular direction (FIGS. 1, 5, and 13). Additionally, compared to convention PTFE, the nodes of the expanded tapes of the present disclosure include active particles. In the expanded tapes of the present disclosure, the active particles are the primary material of the nodes. Without wishing to be bound by theory, such networking may explain the unexpected structural flexibility of the tape material having a relatively high active particle loading. Tapes and expanded tapes having a relatively high active particle loading (e.g., greater than 50 wt-%, 70 wt-%, or 80 wt-%) would have been expected to behave like sintered ceramic material; that is, be brittle and non-flexible. For example, one would expect the structural cohesion to primarily arise from catenation of the active particles with the PTFE fibrils acting solely as a mechanism for adhesion between conglomerates. However, the tapes and expanded tapes of the present disclosure are flexible, having rubber-like qualities. Without wishing to be bound by theory, it is thought that the PTFE fibrils impart flexibility while also acting as bridges allowing all pashes of the material (such as the long-strand PTFE, short-strand PTFE, and active particles) to be tethered at the microscopic level.

Without wishing to be bound by theory, it is theorized that the short- and long-strand PTFE fibrils impart separate characteristics enabling the tapes and expanded tapes to be flexible with little to no active particle shedding. It is postulated that the short-strand PTFE fibrils, being introduced in the form of emulsified PTFE,—are destabilized by the addition of the active particles in the process of making the fibrous matrix from which the machined matrix and the expanded matrix are formed. Because the active particles carry a positive electrostatic charge, and the PTFE fibrils are inherently electronegative charged due to the fluorine moieties, destabilizing the PTFE emulsion leads to charge neutralization between the two species, thus facilitating electrostatic binding of the fibrils and particle conglomerates. These clusters become further entangled with the long-strand PTFE during initial fibrous matrix formation, leading to the networking depicted in FIG. 1. This process is defined in literature for non-fluorinated polymers as flocculation.

After initial flocculation, the long-strand PTFE fibrils are believed to play a role in formation of the mechanically robust tape, since the initial fibrous matrix is a loose conglomerate with no mechanical cohesivity. The long-strand PTFE fibrils are postulated to introduce mechanical binding during the machining process by way of entanglement and shear thickening. Specifically, machining the entangled network leads to unraveling of the long-strand PTFE fibrils and orientation of the fibers along a longitudinal direction relative to the machined direction. Generally, the machined direction informs the longitudinal direction. For example, in some embodiments, the machine direction and the longitudinal direction are similar. Already machined long-stand PTFE fibrils become more resistant to machining as additional force is applied due to the known shear-thickening behavior of PTFE.

The coupling of these two behaviors eventually generates a mechanically robust tape network with definable properties. Further machine machining may include applying extreme force.

The present disclosure describes an expanded tape formed by expanding a tape or machined matrix of the present disclosure having a first machined direction and a second machined direction. The expanded tape includes or is an expanded matrix. The expanded matrix includes a first expanded direction and second expanded direction. The expanded matrix generally includes long-strand PTFE fibrils and nodes. The long-strand PTFE fibrils form an oriented network. The nodes distributed among the oriented network. The oriented network generally includes a first portion of the long-strand PTFE fibrils and a second portion of the long-strand PTFE fibrils. The first portion of the long-strand PTFE fibrils define a first longitudinal direction. The second portion of the long-strand PTFE fibrils define a second longitudinal direction. The nodes generally include active particles and short-strand PTFE distributed among the active particles.

The first longitudinal direction and the first expanded direction of the expanded matrix define an angle alpha-20 (α₂₀) of 0 degrees to 90 degrees, such as 0 degrees to 70 degrees, 0 degrees to 50 degrees, 0 degrees to 30 degrees, 0 degrees to 20 degrees, or 0 degrees to 10 degrees. The second longitudinal direction and the second expanded direction of the expanded matrix define angle alpha-21 (α₂₁) of 0 degrees to 90 degrees, such as 0 degrees to 70 degrees, 0 degrees to 50 degrees, 0 degrees to 30 degrees, 0 degrees to 20 degrees, or 0 degrees to 10 degrees. In some embodiments, the first machined direction and the first expanded direction are the same. In some embodiments, the first machined direction and the first expanded direction are not the same. In some embodiments, the second machined direction and the second expanded direction are the same. In some embodiments, the second machined direction and the second expanded direction are not the same. In some embodiments, 50% or greater of the first portion of the long-strand PTFE fibrils are oriented at the alpha-20 and 50% or greater of the second portion of the long-strand PTFE fibrils are oriented at alpha-21.

The first expanded direction and second expanded direction define an angle alpha-22 (α₂₂). In some embodiments, alpha-22 can be 0 degrees or greater, 5 degrees or greater, 10 degrees or greater, 15 degrees or greater, 20 degrees or greater, 25 degrees or greater, 30 degrees or greater, 50 degrees or greater, or 75 degrees or greater. In some embodiments, alpha-22 can be 90 degrees or less, 75 degrees or less, 50 degrees or less, 30 degrees or less, 25 degrees or less, 20 degrees or less, 15 degrees or less, 10 degrees or less, or 5 degrees or less. In some embodiments, alpha-22 is 0 degrees. In some embodiments, alpha-22 is 90 degrees. In some embodiments, alpha-21 is 90 degrees and alpha-22 is 90 degrees. In some such embodiments, the first machined direction and the first expanded direction are the same and the second machined direction and the second expanded direction are the same.

The present disclosure describes higher order structures that can be made and/or include a tape or expanded tape of the present disclosure. Examples of higher order structures that can include a tape or expanded tape include, but are not limited to, a cinnamon roll structure, packed bed structure, honeycomb structure, pleated structure, and the like. A tape or expanded tape can be configured into a cinnamon roll structure by, for example, rolling the tape or expanded tape into a cylinder form. Additionally, a tape or expanded tape can be configured into a cinnamon roll structure by layering the tape or expanded tape with one or more additional materials and rolling the layers to form a cylinder like structure. A tape or expanded tape can be included in a packed bed structure by, for example, cutting small sections of tape and layering the small sections of tape with or without additional materials in a housing. A tape or expanded tape can be included in a packed bed structure by, for example, by layering discs of the tape or expanded tape and making holes that span the layered discs.

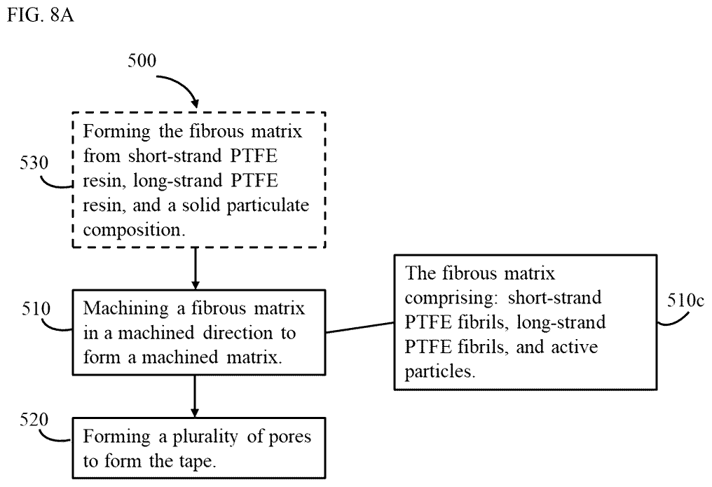

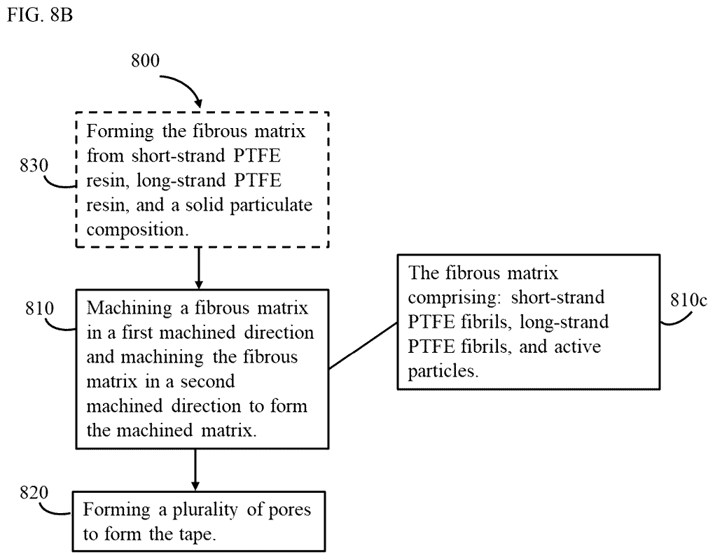

The present disclosure describes a method for making the tapes of the present disclosure. FIG. 8A is a flow diagram outline a method 500 for making a tape of the present disclosure. The method includes machining a fibrous matrix in a machine direction to form a machined matrix (step 510).

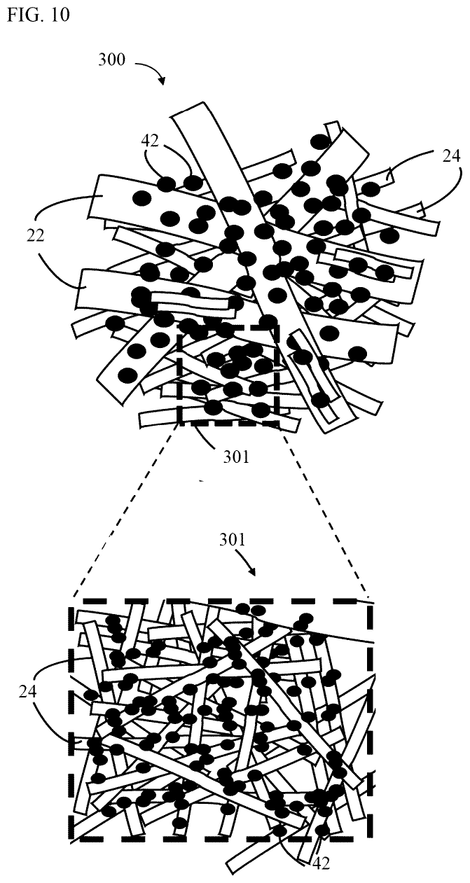

FIG. 10 is a schematic of a fibrous matrix 300. The fibrous matrix 300 includes short-strand PTFE fibrils 24, long-strand PTFE fibrils 22, and active particles 42. Unlike the tapes and expanded tapes of the present disclosure, the long-strand PTFE fibrils 22 and the short-strand PTFE fibrils 24 in the fibrous matrix 300 are both relatively unordered in the fibrous matrix. The active particles 42 are distributed across the fibrous matrix 300 and contact and/or interact with the long-strand PTFE fibrils 22, the short-strand PTFE fibrils 24, or both. The active particles may adopt a catenated structure, a conglomerated structure, or both.

In some embodiments, the method 500 further includes forming the fibrous matrix. the fibrous matrix is formed from short-strand PTFE resin, long-strand PTFE resin, and a solid particulate composition.

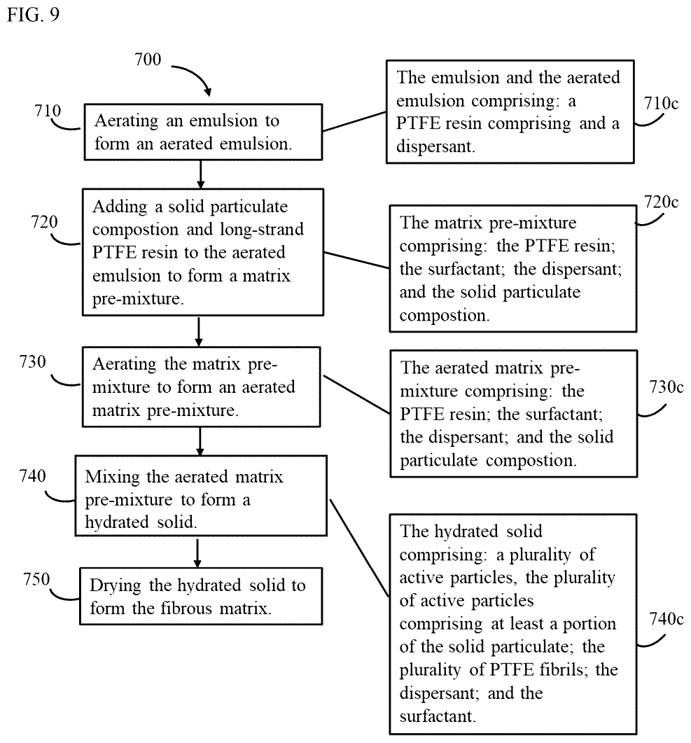

FIG. 9 is a flow diagram outlines a method 700 for making a fibrous matrix. Forming the fibrous matrix may include aerating an emulsion to form an aerated emulsion (step 710), the emulsion and the aerated emulsion including a short-strand PTFE resin and a dispersant (710c). In some embodiments, the emulsion and the aerated emulsion may further include a surfactant, such as, for example, polyethylene glycol trimethylnonyl ether. The dispersant may include water, one or more organic solvents, or both. Examples of organic solvents that may be included in a dispersant include methanol, acetone, tetrahydrofuran, dimethylformamide, acetonitrile, isopropanol, ethanol, ISOPAR-K, and any combinations thereof. An emulsion, mixture, or suspension that has been aerated is characterized by the presence of air bubbles and/or air pockets. For example, an aerated emulsion may be characterized as having bubbles on the surface. Aeration may be accomplished using a variety of techniques such as, mechanical shaking, gas injection, bottom-up bubbling, or combinations thereof.

Method 700 may include adding a solid particulate composition and long-strand PTFE resin to the aerated emulsion to form a matrix pre-mixture (step 720), the matrix pre-mixture including the short-strand PTFE resin, the long-strand PTFE resin, the dispersant, and the solid particle composition (720c). The long-strand PTFE resin and the solid particulate composition may be added at the same time or sequentially. The solid particulate composition includes a solid particulate. The solid particulate includes the active particles and/or the components to form the active particles. In some embodiments, the solid particulate composition includes 100 wt-% of the solid particulate (i.e., no other components are included in the solid particulate composition). In some embodiments the solid particulate composition comprises a solid particulate and a liquid carrier. The liquid carrier may include water or one or more organic solvents such as those described herein.

Method 700 may include aerating the matrix pre-mixture to form an aerated matrix pre-mixture (step 730). The aerated matrix pre-mixture includes the short-strand PTFE resin, the long-strand PTFE resin, the dispersant, and the solid particle composition (730c).

In some embodiments, the matrix pre-mixture and/or the aerated matrix pre-mixture includes one or more additives. Additives include those described herein, such as, for example, polymeric binder, ceramic binders, inorganic fibers, or any combination thereof. The one or more additives can be added to the aerated emulsion in addition to the solid particulate composition and the long-strand PTE resin to form the matrix pre-mixture. The one or more additives can be added to the aerated matrix pre-mixture.

The one or more additives can be added to the aerated emulsion, the aerated matrix pre-mixture as an additive composition. The additive composition includes the one or more additives. In some embodiments, the additive composition includes a liquid carrier. Example liquid carriers include solvents capable of dissolving the additive. For example, in some embodiments when the one or more additives include a polymeric additive, the additive composition includes the polymeric additive and a liquid carrier. The polymeric additive can be dissolved in the liquid carrier. In some embodiments, the additive composition does not include a liquid carrier. In some embodiments, the additive composition is simply the one or more additives. For example, in some embodiments, the one or more additives are added to the aerated emulsion, the aerated matrix pre-mixture, or both as a solid powder or solid fibers.

Method 700 may include mixing the aerated matrix pre-mixture to form a hydrated solid (step 750). The hydrated solid includes the active particles, the short-strand PTFE, the long-strand PTFE, at least a portion of the dispersant, at least a portion of the surfactant (if present), and at least a portion of the liquid carrier if present) (740c). The mixing time may be, for example, from 10 min to 24 hours. Mixing may be accomplished through a variety of methods including mechanical rotation (e.g., on a rotating table), mechanical agitation, immersion blending, vibrational agitation, ultrasonic agitation, or any combination thereof. In some embodiments, it may be desirable to use a mixing technique that does not include shearing forces. Using a mixing technique that does not include shearing forces may result in less fibrilization of the PTFE fibrils which, in turn, may impart characteristics to the composition that make it more processable. Mixing allows for the fibrilization (elongation) of the PTFE resin into PTFE fibrils as well as emulsification of PTFE resin. Mixing also allows for the active particles to become homogenized within the aerated matrix pre-mixture and to form catenated structures and/or conglomerated structure with the fibrilized and/or fibrilizing PTFE fibrils.

Method 700 may include drying the hydrated solid to form the fibrous matrix (step 750). Drying the hydrated solid includes removing at least a portion of the dispersant from the hydrated solid. In embodiments where a surfactant was used, drying includes removing at least a portion of the surfactant from the hydrated solid. In embodiments where a liquid carrier was used, drying includes removing at least a portion of any liquid carrier from the hydrated solid. Drying may be accomplished to varying extents (i.e., the amount of dispersant, liquid carrier, and/or surfactant may be present in the fibrous matrix after drying the hydrated solid). A fibrous matrix after drying may include 50 wt-% or less, 20 wt-% or less, 10 wt-% or less, 5 wt-% or less, or 1 wt-% or less of the dispersant, liquid carrier (if present), and/or surfactant (if present) based on the total weight of the fibrous matrix. Some residual dispersant and/or liquid carrier may be useful for tape and/or expanded tape formation. For example, in embodiments where the dispersant includes a processing aid, the retention of at least a portion of the processing aid may be beneficial for tape formation. As such, in some embodiments, the hydrated solid is dried to an extent such that the composition includes an amount of the dispersant and/or liquid carrier (if present) (e.g., 0.1 wt-% to 50 wt-% water/liquid carrier based on the total weight of the composition) suitable for accomplishing tape formation without the need for the addition of additional dispersant, liquid carrier, or processing aids.

In some embodiments, the fibrous matrix includes a processing aid. A processing aid is a material that may facilitate machining of the fibrous matrix. The processing aid may be added during the formation of the fibrous matrix, following formation of the fibrous matrix, or both. A processing aid may be included in a dispersant or a liquid carrier. Examples of processing aids include mineral spirits, naphtha, and ISOPAR-K (available from Exxon Mobile, Irving, TX). In some embodiments, the processing aid is at least partially removed during the production of the tape or expanded tape. Therefore, a tape or expanded tape of the present disclosure may or may not include residual processing aid.

Returning to FIG. 8A and method 500, the method includes machining the fibrous matrix in a machine direction to form a machined matrix (step 510). Machining is the application of pressure to a fibrous matrix to from a machined matrix of the present disclosure. The fibrous matrix is a malleable solid. During the machining process, the fibrous matrix is flattened and formed into an expanded matrix takin the form of a tape. Without wishing to be bound by theory, it is thought that the application of pressure during the machining process strengthens the interactions between PTFE fibrils, between active particles, and between active particles and PTFE fibrils. Additionally, it is thought that the machining process is involved in creating the oriented network 30 of long-strand PTFE fibrils 22. The long-strand PTFE fibrils align themselves in a longitudinal direction 60 that is the same, or similar, to the machined direction 50 (see FIG. 1). Also, it is thought that the nodes are formed during the machining process.

In some embodiments, prior to machining, the fibrous matrix may be formed into a fibrous matrix tape, the fibrous matrix tape including the fibrous matrix but not the machined matrix. For example, the fibrous matrix may be rolled, compressed, or otherwise flattened into a fibrous matrix tape having a thickness suitable for the machining process. For example, a fibrous matrix may be flattened into a fibrous matrix tape having a thickness of 10 cm or less, 5 cm or less, 2 cm or less, 1 cm or less, or 0.5 cm or less. A fibrous matrix may be flattened into a fibrous matrix tape having a thickness of 0.1 cm or greater, 0.5 cm or greater, 1 cm or greater, 2 cm or greater, or 5 cm or greater. Without wishing to be bound by theory it is thought that flattening the fibrous matrix into a tape, does not induce formation of the expanded matrix because the pressure applied during tape formation is less than that applied during machining. In some embodiments, a fibrous matrix may be rolled through a vertical roller to form a fibrous matrix tape.

Machining may be accomplished using a variety of techniques. For example, a fibrous matrix may be machined by rolling, for example using a nip roller and/or a slip roller. In some embodiments, machining may include sequential steps of applying pressure (a pressure greater than that used to form the fibrous matrix tape) to the fibrous matrix or fibrous matrix tape. For example, a fibrous matrix or fibrous matrix tape may be sequentially fed through a nip roller and/or slip roller having a gap between the rollers that sequentially decreases. For example, a fibrous matrix or fibrous matrix tape may be fed through a horizontal nip roller and/or slip roller having gaps between the rollers that sequentially decrease to form a machined matrix having a desired thickness. In some embodiments, the thickness of the machined matrix is 5000 micrometers or less, 2000 micrometers or less, 1000 micrometers or less, 500 micrometers or less, 200 micrometers or less, or 100 micrometers or less. In some embodiments, the thickness of the machined matrix is 100 micrometers or greater, 200 micrometers or greater, 500 micrometers or greater, 1000 micrometers or greater, or 2000 micrometers or greater.

Method 500 further includes forming a plurality of pores to form the tape. The pores can be formed by any suitable method. In some embodiments, the pores can be formed by laser treatment. In some embodiments, the pores can be formed by pressing on needle gauges or needle counts. In other embodiments, the pores can be formed by etching treatment. In various embodiments, the pores can be formed by high-pressure air or water treatment.

The present disclosure describes a method for making the tapes that includes a machined matrix having a first machine direction and a second machined direction. FIG. 8B is a flow diagram outlining a method 800 for making a tape of the present disclosure. The machining process in the method 800 is consistent with the present disclosure as discussed herein. The method includes machining a fibrous matrix in a first machined direction and machining the fibrous matrix in a second machined direction to form the machined matrix (step 810). In some embodiments, the method 800 further includes forming the fibrous matrix (step 830). The fibrous matrix in the method 810 includes short-strand PTFE fibrils, long-strand PTFE fibrils, and active particles (step 810c). The short-strand PTFE fibrils, long-strand PTFE fibrils, and active particles are consistent with the present disclosure as discussed herein. Method 800 further includes forming a plurality of pores to form the tape (step 820). The plurality of pores may be formed, for example, using techniques described herein.

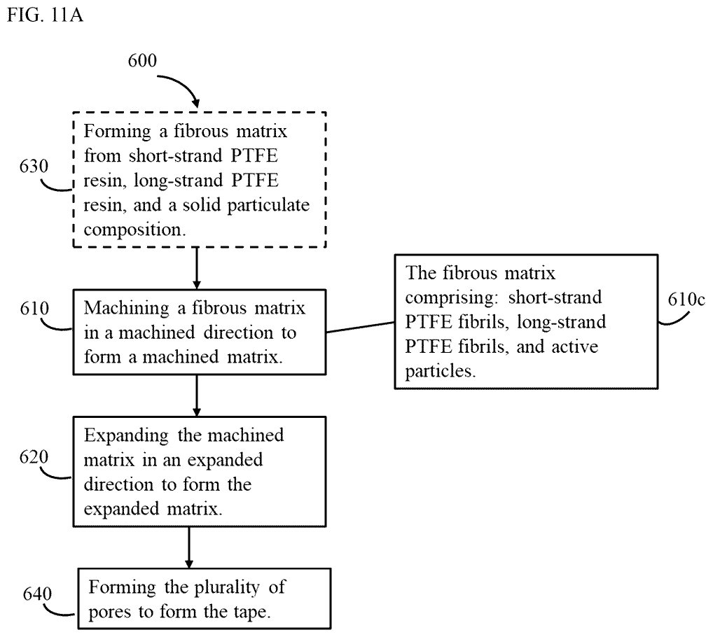

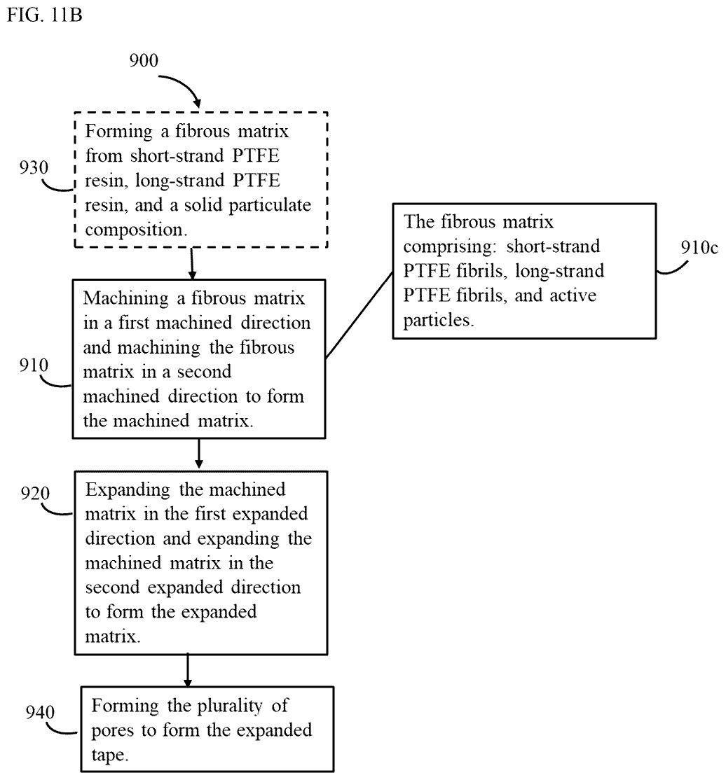

The present disclosure describes a method for making the expanded tapes of the present disclosure. FIG. 11A is a flow diagram outlining a method 600 for making an expanded tape of the present disclosure. The method includes machining a fibrous matrix in a machined direction to form a machined matrix as described herein (step 610). The fibrous matrix in the method 610 includes short-strand PTFE fibrils, long-strand PTFE fibrils, and active particles (step 610c). In some embodiments, the method includes forming a fibrous matrix as described herein (step 630). The method includes expanding the machined matrix in an expanded direction to form the expanded matrix (step 620).

Techniques for expanding the machined matrix include stretching, pulling, or the like along the expanded direction. For example, tensile pulling may be used to expand the machined matrix. A machined-direction orientation machine may be used to expand the machined matrix. The relationship between the machined direction, the longitudinal direction, and the expanded direction may be as described herein. For example, in some embodiments, the machined direction and/or longitudinal direction and the expanded direction define and angle (α₂) that is 0 degrees to 20 degrees (see FIG. 6). In some embodiments, the machined direction and the expanded direction are essentially the same.

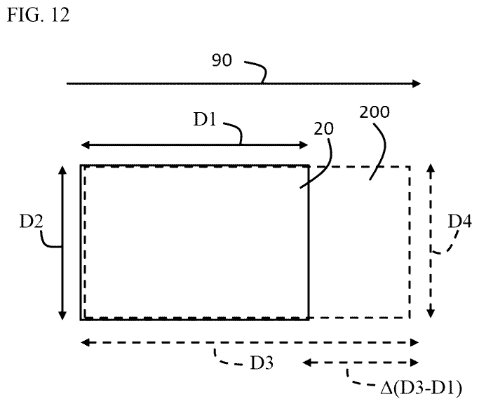

The rate of expansion of the machined matrix may vary. FIG. 12 illustrates how the rate of expansion is calculated. Prior to expansion, the machined matrix 20 has a first dimension D1 and a second dimension D2. Upon expansion along an expanded direction 90, the first machined dimension D1 expands to the first expanded dimension D3 of the expanded matrix 200 and the second machine dimension D2 expands or contracts to the second expanded dimension D4 of the expanded matrix. Generally, the expansion from the first machined dimension D1 to the first expanded dimension D3 is greater than the expansion of the second machined dimension D2 to the second expanded dimension D4. In some embodiments, the expansion from the second machined dimension D2 to the second expanded dimension D4 is minimal. In some embodiments, the contraction from the second machined dimension D2 to the second expanded dimension D4 is minimal.

The rate of expansion is the difference between the first expanded dimension D3 and the first machined dimension D1 (A (D3-D1) in FIG. 12) divided by the amount of time it took to accomplish the expansion. The rate of expansion can be expressed as any unit of length per any unit of time for any starting first machined dimension. In some embodiments, for a machined matrix having a first machined dimension of 1 cm, the rate of expansion is 0.001 millimeters per second (mm/s) or greater, 0.01 mm/s or greater, 0.05 mm/s or greater, 0.07 mm/s or greater, 1 mm/s or greater, 1.5 mm/s or greater, or 2 mm/s or greater. In some embodiments, for a machined matrix having a first machined dimension of 1 cm, the rate of expansion can be 5 mm/s or less, 3 mm/s of less, 1.5 mm/s or less, 1 mm/s or less, 0.07 mm/s or less, 0.05 mm/s or less, or 0.01 mm/s or less.

The extent of expansion can also be expressed as a percent expansion per a unit of time. Percent expansion is calculated as the rate of expansion (D3-D1 divided by the expansion time; units are distance per time) divided by the first expanded dimension D3 and then multiplied by 100. In some embodiments, the percent rate of expansion may be 0.01%/s or greater, 0.1%/s or greater, 0.5%/s or greater, 1%/s or greater, 2%/s or greater, 3%/s or grater, 4%/s or greater, 5%/s or greater, 6%/s or greater, 7%/s or greater, 8%/s or greater, 9%/s or grater, 10%/s or greater, 20%/s or greater, 50%/s or greater, 75%/s or greater, 100%/s or greater, 125%/s or greater, 150%/s or greater, or 175%/s or greater. In some embodiment, the percent rate of expansion may be 200%/s or less, 175%/s or less, 150%/s or less, 125%/s or less, 100%/s or less, 75%/s or less, 50%/s or less, 20%/s or less, 15%/s or less, 12%/s or less, 10%/s or less, 9%/s or less, 8%/s or less, 7%/s or less, 6%/s or less, 5%/s or less, 4%/s or less, 3%/s or less, 2%/s or less, 1%/s or less, 0.5%/s or less, or 0.1%/s or less.

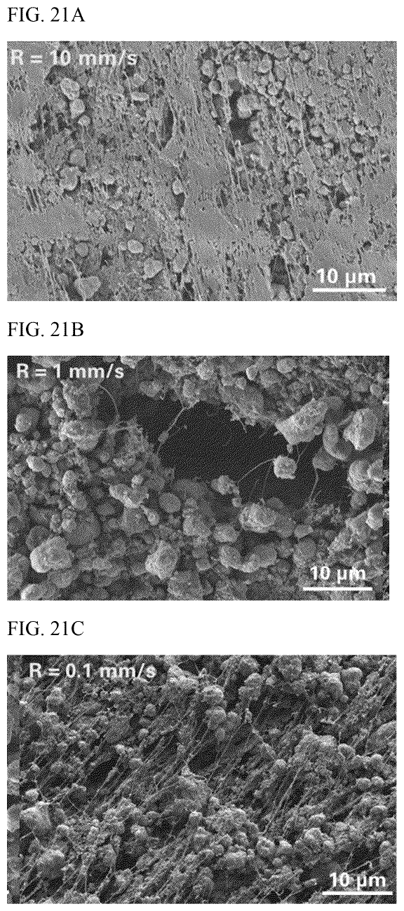

The machined matrixes of the present disclosure exhibit unusual elongation behavior. It was expected that machined matrix having a relatively high load of active particles (e.g., 50 wt-% or greater or 70 wt-% or greater) would not undergo expansion since the majority of its composition is ceramic in nature. For example, ceramics are expected to deteriorate, sinter, and/or shrink when exposed to increased temperatures. Moreover, applying a tensile force to a ceramic body either fails to move the body or leads to mechanical of the ceramic body entirely if the applied force exceeds the modulus of strength. The material also does not expand in a manner which is comparable to that of any known PTFE extrudate. Conventionally expanded PTFE is often expanded at an expansion rate of 30%/s to 5000%/s depending on the properties of the PTFE used and the desired final porosity. The machined matrices of the present disclosure thus have an elongation behavior that differs from both that of ceramic materials and conventional PTFE. Specifically, in contrast to ceramic materials, the machined matrixes of the present disclosure are expandable without deterioration. In contrast to conventional expanded PTFE, the expansion rate of the machined matrixes is lower. Machined matrix expansion rates that are too high may result in expanded tapes that have structures that are less desirable, such as the examples shown in FIG. 21A and FIG. 21B.

Method 600 further includes forming a plurality of pores to form the expanded tape (step 640). The plurality of pores may be formed, for example, according to techniques described herein.

FIG. 11B is a flow diagram outlining a method 900 for making expanded tapes that include expanded matrixes having a first expanded direction and a second expanded direction. The method includes machining a fibrous matrix in a first machined direction and machining the fibrous matrix in a second machined direction to form the machined matrix (step 910). In some embodiments, the method includes forming a fibrous matrix as described herein (step 930). The method includes expanding the machined matrix in the first expanded direction and expanding the machined matrix in the second expanded direction to form the expanded matrix (step 920). The method includes forming the plurality of pores to form the expanded tape (step 940). In some embodiments the machined matrix may be expanded in the first expanded direction and the second expanded direction simultaneously. In some embodiments the machined matrix may be expanded in the first expanded direction and the second expanded direction sequentially. Techniques for expanding the machined matrix is consistent with the present disclosure as discussed herein. The fibrous matrix in the method is consistent with the present disclosure as discussed herein.

### Illustrative Embodiments

The technology described herein is defined in the claims. However, below is provided a non-exhaustive listing of non-limiting embodiments. Any one or more of the features of these embodiments may be combined with any one or more features of another example, embodiment, or aspect described herein.

Embodiment A1 is a tape that includes a machined matrix having a machined direction. The machined matrix includes long-strand PTFE fibrils forming an oriented network. The oriented network includes the long-strand PTFE fibrils. The long-strand PTFE fibrils define a longitudinal direction. The machined matrix includes nodes distributed among the oriented network. The nodes include active particles and short-strand PTFE fibrils distributed among the active particles. The machined matrix includes a plurality of through pores having an average pore opening of 50 micrometers or greater.

Embodiment A2 is the tape of embodiment A1, where the machined matrix has a density of the plurality of pores and the density is 1 pore per square cm to 1000 pores per square cm.

Embodiment A3 is the tape of embodiment A1 or A2, where the tape has an air permeability of 1 cfm or greater at 125 Pa.

Embodiment A4 is the tape of any one of embodiments A1 to A3, where the longitudinal direction and the machined direction of the machined matrix define an angle of 0 degrees to 20 degrees.

Embodiment A5 is the tape of any of embodiments A1 to A4, where 90% or greater of the long-strand PTFE fibrils are oriented at an angle of 0 degrees to 20 degrees relative to the machined direction.

Embodiment A6 is the tape of any of embodiments A1 to A5, where the machined matrix includes 60 wt-% or greater of the active particles.

Embodiment A7 is the tape of any of embodiments A1 to A6, where the machined matrix includes 80 wt-% or greater of the active particles.

Embodiment A8 is the tape of any of embodiments A1 to A7, where the machined matrix includes 0.01 wt-% to 20 wt-% of the short-strand PTFE fibrils.

Embodiment A9 is the tape of any of embodiments A1 to A8, where the machined matrix includes 0.01 wt-% to 20 wt-% of the long-strand PTFE fibrils.

Embodiment A10 is the tape of any of embodiments A1 to A9, where the active particles include a catalyst, an electroactive material, an absorbent, an adsorbent, a growth seed, a metal-organic framework, or a combination of two or more thereof. The adsorbent can be a physisorbent, a chemisorbent, or a physisorbent-chemisorbent hybrid.

Embodiment A11 is the tape of embodiment A11, where the catalyst is capable of ozone destruction.

Embodiment A12 is the tape of embodiment A10 or A11, where the catalyst comprises manganese oxide, copper oxide, cerium dioxide, or a combination of two or more thereof.

Embodiment A13 is the tape of embodiment A10, where the adsorbent is capable of adsorbing a basic gas, an acidic gas, a gaseous organic compound, a gaseous inorganic compound, or a combination of two or more thereof.

Embodiment A14(a) is the tape of any embodiments A1 through A13, where the tape includes an additive.

Embodiment A14(b) is the tape of any embodiments A1 through A13, where the machined matrix includes an additive.

Embodiment A15 is the tape of embodiment A14, where the additive is a ceramic binder, a polymeric binder, or both.

Embodiment A16 is the tape of embodiment A15, where the ceramic binder includes kaolinite, bentonite, silicon carbide, fumed silica, zeolites, or any combination thereof.

Embodiment A17 is the tape of embodiment A16, where the polymeric binder includes polyamide (Nylon); polyamideimide (Torlon); polyacrylate; polyurethanes; styrene-butadiene rubber (SBR rubber); polyvinyl alcohol (PVA); polyvinyl chloride (PVC); silicone; polypropylene; polyethylene; aramid (Kevlar); polystyrene; poly(ethylene terephthalate) (PET), polyvinylidene fluoride (PVDF); polyvinyl acetate; polyacrylonitrile; already formed PTFE fibers, or any combination thereof.

Embodiment A18 is the tape of embodiment A15, where the polymeric binder includes gelatin, methylcellulose, ethylcellulose, pectin, polyethylene glycol, sodium alginate, agar, xanthan gum, or any combination thereof.

Embodiment A19 is the tape of embodiment A14, where the additive includes inorganic fibers.

Embodiment A20 is the tape of embodiment A19, where the inorganic fibers include carbon fiber, activated carbon fiber, metal fiber, ceramic fibers (e.g., fiberglass), or any combination thereof.

Embodiment A21(a) is the tape of any of embodiments A14 through A20, where the tape includes 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the tape.

Embodiment A21(b) is the tape of any of embodiments A14 through A20, where the machined matrix includes 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the machined matrix.

Embodiment A22(a) is the tape of any of embodiments A14 to A20, where the tape includes 0.1 wt-% to 10 wt-%, 1 wt-% to 10 wt-% or 5 wt-% to 10 wt-% total additives based on the total weight of the tape.

Embodiment A22(b) is the tape of any of embodiments A14 to A20, where the machined matrix includes 0.1 wt-% to 10 wt-%, 1 wt-% to 10 wt-% or 5 wt-% to 10 wt-% total additives based on the total weight of the machined matrix.

Embodiment B1 is an expanded tape that includes an expanded matrix having an expanded direction. The expanded matrix includes long-strand PTFE fibrils forming an oriented network. The oriented network includes the long-strand PTFE fibrils. The long-strand PTFE fibrils define a longitudinal direction. The expanded matrix includes nodes distributed among the oriented network. The nodes include active particles and short-strand PTFE distributed among the active particles. The expanded matrix includes a plurality of through pores having an average size of 50 micrometers or greater.

Embodiment B2 is the expanded tape of embodiment B1, where the expanded matrix has a density of the plurality of pores and the density is 1 pore per square cm to 1000 pores per square cm.

Embodiment B3 is the expanded tape of embodiment B1 or B2, where the expanded tape has an air permeability of 1 cfm or greater at 125 Pa.

Embodiment B4 is the expanded tape of any of embodiments B1 to B3, where the longitudinal direction and expanded direction define an angle of 0 degrees to 20 degrees.

Embodiment B5 is the expanded tape of any of embodiments B1 to B4, where 90% or greater of the long-strand PTFE fibrils are oriented at an angle of 0 degrees to 20 degrees relative to the expanded direction.

Embodiment B6 is the expanded tape of any of embodiments B1 to B5, where the expanded matrix includes 60 wt-% or greater of the active particles.

Embodiment B7 is the expanded tape of any of embodiments B1 to B6, where the expanded matrix includes 80 wt-% or greater of the active particles.

Embodiment B8 is the expanded tape of any of embodiments B1 to B7, where the expanded matrix includes 0.01 wt-% to 20 wt-% of the short-strand PTFE fibrils.

Embodiment B9 is the expanded tape of any of embodiments B1 to B8, where the expanded matrix includes 0.01 wt-% to 20 wt-% of the long-strand PTFE fibrils.

Embodiment B10 is the expanded tape of any of embodiments B1 to B9, where the active particles include a catalyst, an electroactive material, an absorbent, an adsorbent, a growth seed, a metal-organic framework, or a combination of two or more thereof. The adsorbent can be a physisorbent, a chemisorbent, or a physisorbent-chemisorbent hybrid.

Embodiment B11 is the expanded tape of embodiment B10, where the catalyst is capable of ozone destruction.

Embodiment B12 is the expanded tape of embodiment B11 or B12, where the catalyst includes manganese oxide, copper oxide, cerium dioxide, or a combination of two or more thereof.

Embodiment B13 is the expanded tape of embodiment B10, where the adsorbent is capable of adsorbing a basic gas, an acidic gas, a gaseous organic compound, a gaseous inorganic compound, or a combination of two or more thereof.

Embodiment B14(a) is the expanded tape of any embodiments B1 through B13, where the expanded tape includes an additive.

Embodiment B14(b) is the expanded tape of any embodiments B1 through B13, where the expanded matrix includes an additive.

Embodiment B15 is the expanded tape of embodiment B14, where the additive is a ceramic binder, a polymeric binder, or both.

Embodiment B16 is the expanded tape of embodiment B15, where the ceramic binder includes kaolinite, bentonite, silicon carbide, fumed silica, zeolites, or any combination thereof.

Embodiment B17 is the expanded tape of embodiment B16, where the polymeric binder includes polyamide (Nylon); polyamideimide (Torlon); polyacrylate; polyurethanes; styrene-butadiene rubber (SBR rubber); polyvinyl alcohol (PVA); polyvinyl chloride (PVC); silicone; polypropylene; polyethylene; aramid (Kevlar); polystyrene; poly(ethylene terephthalate) (PET), polyvinylidene fluoride (PVDF); polyvinyl acetate; polyacrylonitrile; already formed PTFE fibers, or any combination thereof.

Embodiment B18 is the expanded tape of embodiment B15, where the polymeric binder includes gelatin, methylcellulose, ethylcellulose, pectin, polyethylene glycol, sodium alginate, agar, xanthan gum, or any combination thereof.

Embodiment B19 is the expanded tape of embodiment B14, where the additive includes inorganic fibers.

Embodiment B20 is the expanded tape of embodiment B19, where the inorganic fibers include carbon fiber, activated carbon fiber, metal fiber, ceramic fibers (e.g., fiberglass), or any combination thereof.

Embodiment B21(a) is the expanded tape of any of embodiments B14 through B20, where the expanded tape includes 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the tape.

Embodiment B21(b) is the expanded tape of any of embodiments B14 through B20, where the expanded matrix includes 1 wt-% to 50 wt-%, 5 wt-% to 50 wt-%, 10 wt-% to 50 wt-%, 10 wt-% to 40 wt-%, 10 wt-% to 30 wt-%, 10 wt-% to 20 wt-%, or 20 wt-% to 50 wt-% total additives based on the total weight of the expanded matrix.

Embodiment B22(a) is the expanded tape of any of embodiments B14 to B20, where the expanded tape includes 0.1 wt-% to 10 wt-%, 1 wt-% to 10 wt-% or 5 wt-% to 10 wt-% total additives based on the total weight of the expanded tape.

Embodiment B22(b) is the expanded tape of any of embodiments B14 to B20, where the expanded matrix includes 0.1 wt-% to 10 wt-%, 1 wt-% to 10 wt-% or 5 wt-% to 10 wt-% total additives based on the total weight of the expanded matrix.

Embodiment C1 is a method of making the tape of any of embodiments A1 through A22, the method includes machining a fibrous matrix in a machined direction to form the machined matrix. The fibrous matrix includes short-strand PTFE fibrils; long-strand PTFE fibrils; and active particles. The method includes forming the plurality of pores to form the tape.

Embodiment D1 is a method of making the expanded tape of any of embodiments B1 through B22, the method includes machining a fibrous matrix in a machined direction to form the machined matrix. The fibrous matrix includes short-strand PTFE fibrils; long-strand PTFE fibrils; and active particles. The method including expanding the machined matrix in the expanded direction to form the expanded matrix. The method includes forming the plurality of pores to form the tape.

Embodiment E1 is the method of any of embodiments C1 through D1, where the machined direction, the longitudinal direction, and the expanded direction (if expanded (method D1)) define an angle of 0 degrees to 20 degrees.

Embodiment E2 is the method of any of embodiments C1 through E1, where the machined direction and the expanded direction define an angle of 0 degrees to 20 degrees.

Embodiment E3 is the method of any of embodiments C1 through E2, where forming a plurality of pores further includes puncturing the machined matrix or the expanded matrix with a puncturing device.

Embodiment E4 is the method of embodiment E3, where the punching device comprises a needle, a pressurized gas, pressurized water, or any combination thereof.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, MO; Carus, Peru, IL; Calgon Carbon, Moon Township, PA; Ultramet, Los Angeles, CA; Chemours, Wilmington, DE; or may be synthesized by conventional methods.

The following abbreviations may be used in the following examples: Mn=number average molecular weight; ppm=parts per million; ppb=parts per billion; mL=milliliter; L=liter; LPM=liters per minute; m=meter, mm=millimeter, min=minutes; s=seconds; cm=centimeter, μm=micrometer, kg=kilogram, g=gram, min=minute, s=second, h=hour, ° C.=degrees Celsius, °=degrees, ° F.=degrees Fahrenheit; wt-%=weight percent; M=molar; %=percent, and DI water=deionized water.

Table 1 is a materials table giving a list of components used in the Examples and their associated vendor source, abbreviation, and chemical abstract service (CAS) number.

TABLE 1
Materials and associated information.

| Material | Vendor | Abbreviation | CAS# |
|---|---|---|---|
| CARULTIE 400 | Carus | CARULITE | — |
| (MnO₂) | | | |
| K₂CO₃ (99%) | Sigma-Aldrich | — | 584-08-7 |
| Emulsified | Sigma-Aldrich | PTFE-E | 9002-84-0 |
| Polytetrafluoroethylene | | Surfactant | |
| in water and | | abbreviated | |
| polyethylene glycol | | as PEG-TMNE | |
| trimethylnonyl ether | | | |
| (60% PTFE) | | | |
| Polytetrafluoroethylene | Sigma-Aldrich | PTFE-12 | 9002-84-0 |
| powder (<12 μm) | | | |
| Polytetrafluoroethylene | Chemours | PTFE-601X | — |
| resin (400 micrometers) | | (601X) | |
| Coconut Shell | Calgon | CSAC | EN186 |
| Activated Carbon | | | |
| CeO₂ (<5 micrometer) | Sigma Aldrich | CeO₂ | 1306-38-3 |
| Ethanol (ACS Grade) | Sigma-Aldrich | EtOH | 64-17-5 |
| Distilled Water | In-house | DI | — |
| Isopropanol | Sigma-Aldrich | IPA | 67-63-0 |
| Isopar-K | Exxon-Mobil | — | 90622-57-4 |
| polyethylene glycol | Sigma-Aldrich | (Tergitol, or | 60828-78-6 |
| trimethylnonyl ether | | PEG-TMNE) | |

### Test Methods:

### Ozone Destruction Test

Ozone destruction was assessed using the following test method. The samples were subjected to a temperature ramp with air flowrate of 1.3 liters per minute (1.3 LPM), ozone generation=2V (TG-10; Ozone solutions), downstream temperature of 80-160 degrees Fahrenheit (26.6-76.1 degrees Celsius). The ozone concentration was measured using a Model 202 2B Technologies O₃ detector (available from 2B Technologies in Zurich, Switzerland). A blank experiment under these conditions was performed and the experimental O₃ conversion was calculated from the blank O₃ concentration at each temperature point because the thermal stability of O₃ decreases at elevated temperature. The turnover ratio per catalyst weight was then used to account for changes in catalytic activity stemming from changes in sample mass used for testing. The turnover rate is calculated as follows:

$$Turnover ( \frac{ppb}{{g}_{catalyst} \cdot min} ) = \frac{{C}_{0} - {C}_{t}}{{g}_{catalyst}}$$

where C₀, Cₜ, and g_{catalyst} being the i) measured blank O₃ concentration at a specific temperature with 2 LPM flow (parts per billion; ppb), ii) measured O₃ concentration at a specific temperature with 2 LPM flow in the catalyst-containing bed (ppb), and iii) weight of catalyst material loaded on the plate (g), respectively.

### Dimensional Analysis

Dimensional analysis and the topography analysis of the various compositions of the examples were accomplished via scanning electron microscopy (SEM) on a JSM-7100F microscope. Prior to imaging the samples, samples were sputter coated for 120 seconds with gold/palladium to prevent charging. Measurements to calculate the average length of long-strand PTFE fibrils, the average resin particle size of long-strand PTFE resin; the average length of short-strand PTFE fibrils; the average resin particle size of short-strand PTFE resin; the average diameter of short-strand PTFE fibrils, the average diameter of long-strand PTFE fibrils; the average particle size of the plurality of active particles; the average particle size of the free active particles; and the average porosity were then taken using ImageJ software. Ten replicate measurements of the lengths/widths/diameters/particle sizes were taken to generate the average for various elements.

### Compositional Analysis

The amount of each component in the machined matrixes and expanded matrixes are calculated according to the following method. The solid loading capacity of each component (e.g., active particles, short-strand PTFE, long-strand PTFE) of machined matrix and expanded matrix after heat treatment was calculated from the initial fibrous matrix formulations by assuming homogeneous mixing of the solids and full loss of the dispersant/surfactant mixture. As one example, the solids content for CARULITE/PTFE-12 μm was calculated by using a 21.3 g basis of material; comprised by weight of 13.3 g CARULITE, 5 g PTFE-E, and 3 g of PTFE-12. Knowing that the PTFE-E material was comprised of 60 wt-% PTFE solids as detailed by the manufacturer, the weight of PTFE solids derived thereof was the product of the weight fraction of PTFE solids and the weight used (e.g., if 5 g of PTFE-E was used, then 60%_{PTFE-Solids}×5 gₑₘᵤₗₛᵢₒₙ=3 g_{PTFE solids}). The solids content for each component were then calculated on a dry component basis-which did not consider any contribution of the water or surfactant components—as follows:

$${X}_{i} = \frac{{M}_{i}}{{M}_{1} + {M}_{2} … ++ {M}_{n}} \cdot 100 \%$$

where Xᵢ and Mᵢ are defined as the weight percentage of a singular component after drying and the individual mass of the solid component (g) used in paste formulation without any solvent, respectively. So, for example, if a composition including 10 g CARULITE, 5 g PTFE-E, and 3 g PTFE-12 were formulated, then the solid fraction of CARULITE could be defined as:

$${X}_{CARULITE} = \frac{10 g ( carulite )}{10 g ( carulite ) + 3 g ( P T F E - 12 ) + 60 \% * 5 g ( P T F E - E )} \cdot 100 \% .$$

On this basis, the exemplary fraction—i.e., loading or capacity—of CARULITE would then be 62.5 wt-% and the material would include 16.6 wt-% short-strand PTFE fibrils, and 27.7 wt-% long-strand PTFE fibrils.

### Permeability

Permeability was assessed across a 3-inch circular orifice plate using a test pressure of 125 Pa using a FX 3310 Air Permeability Tester (TEXTEST, Columbus, GA).

### Example 1: Fibrous Putty Formation

Fibrous putties of the Examples were formed using the following general technique:

1. In a first container, a solid particulate composition that includes the active particles and/or the components to make the active particles and PTFE-12 were mixed. In some cases, the solid particulate composition included only solids.

2. In a second bottle, an emulsion of PTFE-E (short-strand PTFE resin) was aerated by agitation.

3. The aerated emulsion of PTFE-E was added to the first container. The first container was gently agitated to incorporate the emulsion into the solids of the first container.

4. A dispersant and/or a processing aid were added to the first bottle. The first container was vigorously agitated to incorporate the dispersant and/or processing aid. The dispersant included water or water and IPA.

5. Additional dispersant was added to the first container and the first container vigorously agitated.

6. The first container was agitated by rolling on a mixing table at 30 rotations per minute for 24 hours. After 24 hours a hydrated solid formed.

7. The hydrated solid was removed from the first container and wrapped in paper towels. This step was included to remove excess dispersant from the hydrated solid. The hydrated solid was allowed to rest in the paper towels for five minutes. The paper towels were replaced and the drying processes repeated two more times

### Example 2: Methods of Machining to Form a Tape

Machined matrixes (tapes) of the Examples were formed using the following general technique:

1. Palm size pieces of a fibrous matrix were flattened to a thickness of about 0.5 cm using a rolling pin and limited amounts of applied pressure. The fibrous matrix was first rolled in one direction and then rolled in a second direction that was 90 degrees to the first direction. The thickness of the flattened fibrous matrix was measured using a caliper.

2. A hand crank operated slip roller was used to machine the flattened fibrous matrix at ambient temperature. The flattened fibrous matrix was rolled through increasingly narrower restrictions on a slip roller. Specifically, the flattened fibrous matrix was unidirectionally rolled (along a machined direction) through a slip roller gap of 1 cm (two times), 0.5 cm (two times), and 0.1 cm (two times). In Example 3, the machined tape was then rolled through the slip roller with a gap of 0.1 cm in a direction 90 degrees to the machined direction used for the previous rolling steps. In Example 4, the cross-machining step was omitted.

3. The machined matrix (machined tape) was dried in a high flow air fired for 1 hour at 100 degrees Celsius. It is noted that the machined tapes and expanded tapes retain mechanical stability to at least 250 degrees Celsius, with the expectation of stability up to ˜350 degrees Celsius after which point PTFE begins to degrade.

### Example 3: Methods of Expansion to Form an Expanded Tape

Expanded matrixes (expanded tapes) of the Examples were formed using the following general technique:

1. Machined matrixes were cut into segments (e.g., 1 cm by 1 cm segments) at an angle relative to machined direction.

2. Each segment was secured to a dog bone holder on an RSA-G2 analyzer (TA Instruments, New Castle, DE) for dynamic mechanical analysis (DMA).

3. The dog bone holder and RSA-G2 analyzer was used to stretch the machined tape in an expanded direction. The rate of expansion was varied (0.1 mm/s, 1 mm/s, and 10 mm/s). The temperature of expansion was 175 degrees Celsius, or 200 degrees Celsius, or 225 degrees Celsius.

For clarity, FIG. 19 illustrates the relationship between machined direction, cut angle, and expanded direction. The machined matrix 20 has an oriented network of that includes long-strand PTFE fibrils 22 oriented substantially along the machined direction 50. 1 cm by 1 cm segments of the machined matrix are cut out at various angles (0 degrees=box A; 75 degrees=box B; and 90 degrees=box C) such that the segments have straight edges that can be attached to the dog bone holder. The segments are expanded in an expanded direction 90. The cut angle is the angle defined by the machined direction 50 and the expanded direction 90. Stated differently, the cut angle is alpha-2.

### Example 4: Unexpected Behavior Observed when Processing a Fibrous Putty

In this Example, the unusual behavior observed when processing a fibrous putty is described. This unusual behavior led to experiments of forming a tape and expanded tape.

A fibrous matrix was made according to Example 1 with 46 wt-% CARULITE, 3.5 wt-% PTFE-601X, 3.5 wt-% PTFE-E, 35.3 wt-% water, and 10.6 wt-% IPA.

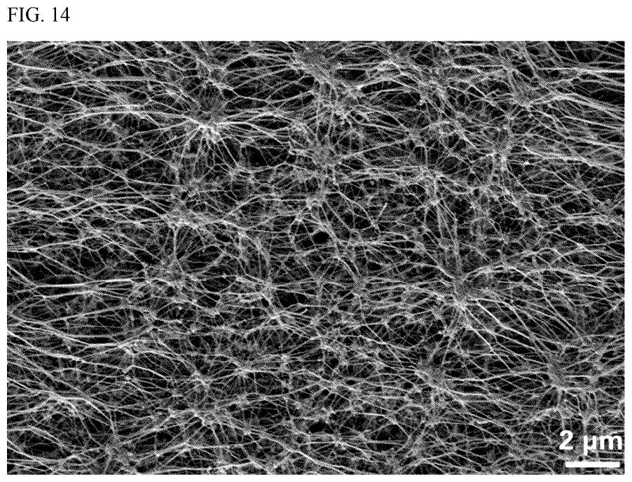

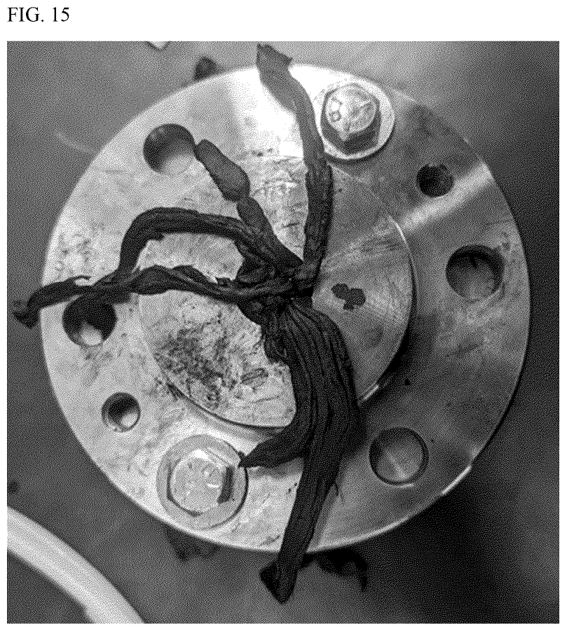

Attempts at extruding the fibrous matrix into a self-supporting honeycomb structure was unsuccessful. Extrusion was performed via ram extrusion through a channeled die. Due to complications in the barrel design, extrusion of the honeycomb structure was not successful. However, it was observed that the fibrous matrix became mechanically stable under applied load; albeit not forming the desired geometry due to unequal rates of flow at the die outlet (FIG. 15). More specifically, the fibrous matrix after extrusion had a coherent solid phase without any distinguishable PTFE resin solids being visible. Further, it was observed that structural defects in the fibrous putty surface followed the direction of applied force. Such behavior is somewhat consistent the behavior observed in conventional PTFE processing, in that applying shear force to PTFE generally gives rise to orientation of PTFE fibrils along the machine direction stimming from expansion by way of applied frictional resistance. However, in conventional PTFE processing, fibrillation of the resin is undesired given that it leads to fibril severance, poor flow behavior, and failed extrudate cohesion. When handled improperly, conventional PTFE resin extrudates lose flexibility and completely fail to flow. In contrast, the failed extrudate in FIG. 15 remained flexible and malleable, even though it did not extrude in a uniform manner. Regarding the malleability and homogeneity of the extrudate, it was theorized that a radial force applied to the material may further induce binding between the plurality of PTFE fibrils by way of lengthening the fibrils, thus leading to shear thickening as well as leading to entanglement of the oriented long-strand fibrils.

### Example 5: Tape Formation Using Hand Rolling

A fibrous matrix was made according to Example 1 with 37.7 wt-% CARULITE, 11.3 wt-% PTFE-601X, 14.2 wt-% PTFE-E, and 36.8 wt-% water.

To make a tape, the fibrous putty was elongated with a rolling pin by hand-machining it in a singular direction. It was observed that unidirectional rolling strengthened the putty along the direction of applied force; however, the resulting material was easily shredded by applying force in the perpendicular plane to machining. The rolling technique was logically applied to the perpendicular (i.e., cross-machined) direction in the 90 degrees plane relative to initial rolling direction, whereafter the composite became remarkably stronger and showed dramatically reduced particle shedding. As shown in FIG. 16, the machined putty appeared as a ˜100 micrometers thick tape which was observed as having a surface texture similar to that of latex. The tape was cohesive after drying and included 65.5 wt-% MnO₂ (19.7 wt-% PTFE-601X, and 14.8 wt-% PTFE-E) by weight.

### Example 6: Tape Formation Using a Slip Roller and Bidirectional Machining

This Example describes the formation and properties of various machined matrixes.

Nine fibrous matrices having varying formulations were made according to Example 1. The fibrous matrices were machined into machined matrixes (tapes) according to Example 2. In addition to machining in a first direction, the fibrous matrixes were further rolled through the slip roller with a gap of 0.1 cm in a direction 90 degrees to the first machined direction. Table 2 shows the formulations used to make the fibrous matrixes and Table 3 shows the properties of the machined matrixes (tapes) formed from the fibrous matrixes. In Table 2 and Table 3, the IDs of the fibrous matrices and machined matrices are correlated. For example, machined matrix 1 was formed from fibrous matrix 1. A higher force was applied to machine fibrous matrixes 1 through 7 as compared to fibrous matrixes 8 and 9. In fibrous matrixes 8 and 9, IPA was added as a processing aid.

TABLE 2

| Fibrous | | | | | |
|---|---|---|---|---|---|
| Matrix | CARULITE | PTFE-601X | PTFE-E | Water | IPA |
| ID. | (wt-%) | (wt-%) | (wt-%) | (wt-%) | (wt-%) |
| 1 | 33.8 | 20.4 | 12.7 | 33.1 | 0.0 |
| 2 | 34.7 | 18.3 | 13.1 | 33.9 | 0.0 |
| 3 | 35.7 | 16.1 | 13.4 | 34.9 | 0.0 |
| 4 | 37.7 | 11.3 | 14.2 | 36.8 | 0.0 |
| 5 | 38.8 | 8.7 | 14.6 | 37.9 | 0.0 |
| 6 | 39.9 | 6.0 | 15.0 | 39.0 | 0.0 |
| 7 | 47.0 | 7.1 | 7.1 | 38.9 | 0.0 |
| 8 | 47.0 | 3.5 | 3.5 | 35.3 | 10.6 |
| 9 | 48.5 | 2.2 | 1.8 | 36.5 | 10.9 |

TABLE 3

| Machined | | | |
|---|---|---|---|
| Matrix | CARULITE | PTFE-601X | PTFE-E |
| ID. | (wt-%) | (wt-%) | (wt-%) |
| 1 | 54.7 | 32.9 | 12.3 |
| 2 | 57.1 | 30.0 | 12.9 |
| 3 | 59.6 | 26.9 | 13.5 |
| 4 | 65.5 | 19.7 | 14.8 |
| 5 | 68.9 | 15.5 | 15.5 |
| 6 | 72.7 | 10.9 | 16.4 |
| 7 | 80.6 | 12.1 | 7.3 |
| 8 | 89.3 | 6.7 | 4.0 |
| 9 | 93.7 | 4.2 | 2.1 |

As shown in Table 3, the machined matrixes (tapes) had active particle loading of up to 93.7 wt-% (machined matrix 9). These particles loadings are extremely high. For example, the machined matrix 9 is almost entirely active particles. Such high loadings may be advantageous due to the high amount of active material in a given surface area of a machined matrix (tape).

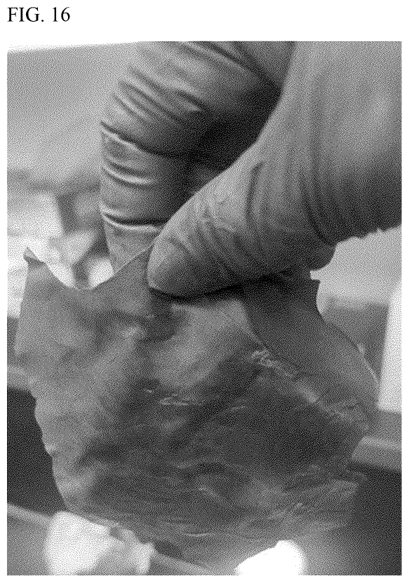

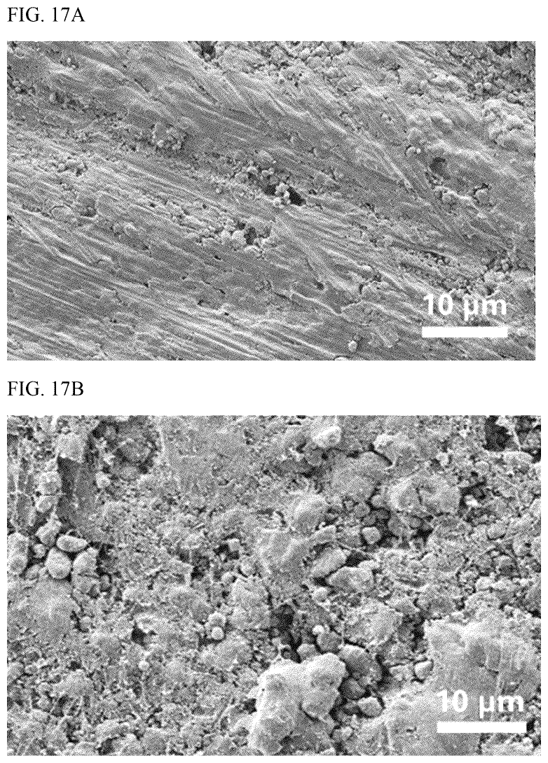

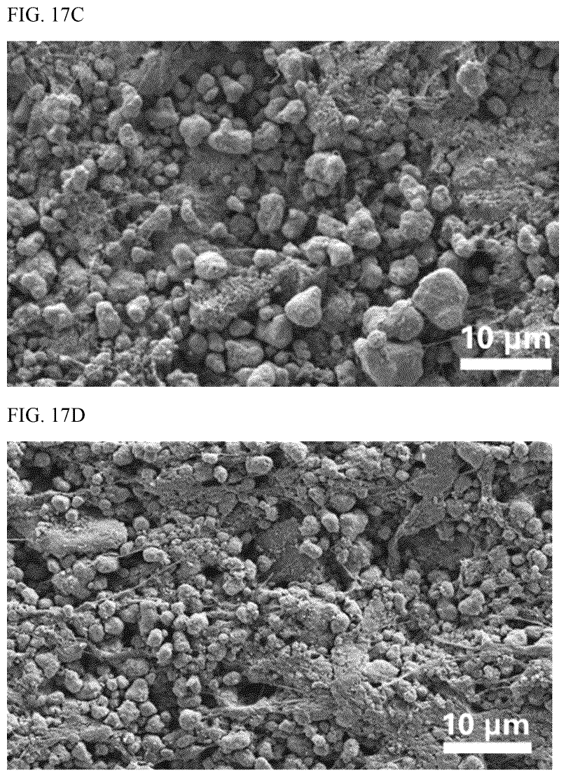

Distinguishable active particles have a higher surface area that is accessible to chemicals contacting the machined matrix. To determine the accessibility of the active particles, the surface morphology of the machined matrixes 1, 4, 6, and 8 were examined using scanning electron microscopy (SEM). As shown in FIG. 17A-17B the surface is largely nonporous at elevated PTFE loadings. For example, machined matrix 1 (catalyst loading of 54.7 wt-%) displayed a texture comparable to that of machined metal or wet-laid polymer (FIG. 17A). As the catalyst loading was increased to 66% (machined matrix 4; FIG. 17B) and 72% (machined matrix 6; FIG. 17C) the surface showed more individualized active particles and some discernable spacing between the active particles. At the highest catalyst loading (93.7 wt-%; machined matrix 9; FIG. 17D) where the surface was observed as being porous with highly distinguishable catalyst particles.

The machined tapes exhibited surprising behavior. It was originally anticipated that the machined tapes would behave similar to conventional PTFE extrudates given that the short-stand PTFE/long-strand PTFE was hypothesized as the source of mechanical strength and abrasion resistance for the machined matrix. Conventional PTFE extrudates that do not contain active particles are expanded using high forces at fast rates in order to effectively induce fiber expansion. In contrast, it was observed that applying small amounts of force to the machined matrixes mobilized the PTFE fibril/particle phase and allowed localized thinning of the machined matrixes in the direction of applied force.

From an activity standpoint, retaining distinct active particles may be advantageous. For example, it is expected the closed surface in FIG. 17A to have lower active site accessibility. In contrast, it is expected that machined matrixes (tapes) having an active particle loading of 72% or greater may enhance catalytic performance due to increased active particle accessibility.

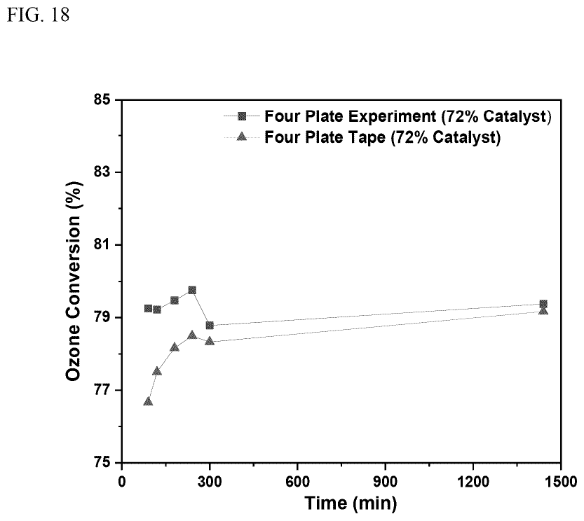

To test the activity of the activity of the active particles, the ability of machined matrix 6 to deconstruct ozone was tested according to the ozone destruction where the temperature was 100 degrees Celsius, the flowrate was 1.2 L/min, and the inlet ozone concentration was 140,000 ppb O₃. In either experiment, ˜35 in² of material was packed into the bed such that the contaminated air could flow parallel to the active material surface. As shown in FIG. 18, machined matrix 6 yielded ozone destruction behavior which was nearly identical to that of the same fibrous matrix that was not machined (flat plate) (80% conversion, no loss in performance); lying within the margin of acceptable error for the experimental setup. Such results indicated high activity in the machined matrix (tape), which was especially unexpected considering that i) the machined matrix underwent no efforts towards fiber expansion and ii) the experiment was performed under 150X atmospheric concentration.

### Example 7: Expanded Tape Formation Using a Slip Roller and Unidirectional Machining

This Example described the process and properties of expanded matrixes (expanded) tapes formed from machined matrixes. The machined matrixes were formed from fibrous matrix 7 that was machined according to Example 2 in a singular machined direction. The machined matrix was then cut into 1 cm segments and each segment subjected to expansion in an expanded direction that had an angle (alpha-2) of 0 degrees, 45 degrees, or 90 degrees relative to the machined direction. Expansion was accomplished according to Example 3 where the rate of expansion (0.1 mm/s, 1 mm/s, or 10 mm/s) and the temperature of expansion (175 degrees Celsius or 200 degrees Celsius) were varied. The expansion behavior was then assessed as a function of pull speed, temperature, and cut angle using the design of experiments in Table 4.

TABLE 4

| | Expansion | |
|---|---|---|
| Temperature | Speed | |
| (degrees Celsius) | (mm/s) | Cut Angle (degree) |
| 175 | 0.1 | 0 |
| | | 45 |
| | | 90 |
| 175 | 1 | 0 |
| | | 45 |
| | | 90 |
| 175 | 10 | 0 |
| | | 45 |
| | | 90 |
| 200 | 0.1 | 0 |
| | | 45 |
| | | 90 |
| 200 | 1 | 0 |
| | | 45 |
| | | 90 |
| 200 | 10 | 0 |
| | | 45 |
| | | 90 |
| 225 | 0.1 | 0 |
| | | 45 |
| | | 90 |
| 225 | 1 | 0 |
| | | 45 |
| | | 90 |
| 225 | 10 | 0 |
| | | 45 |
| | | 90 |

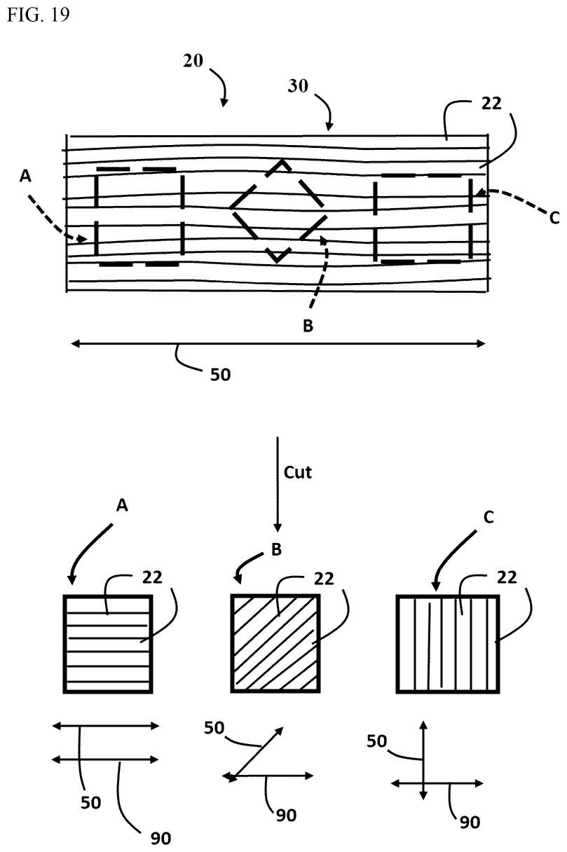

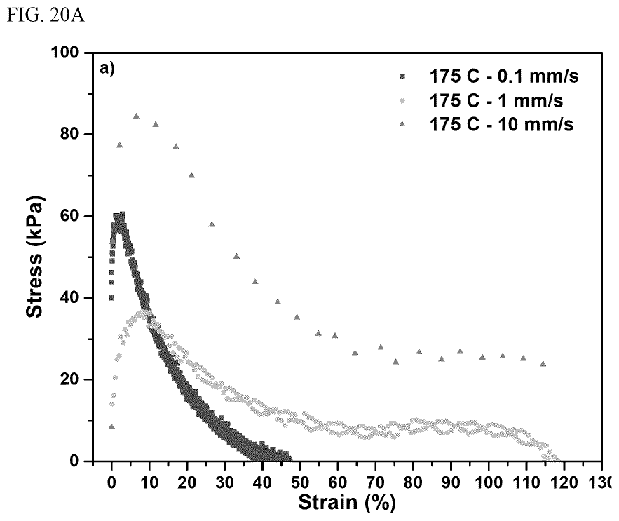

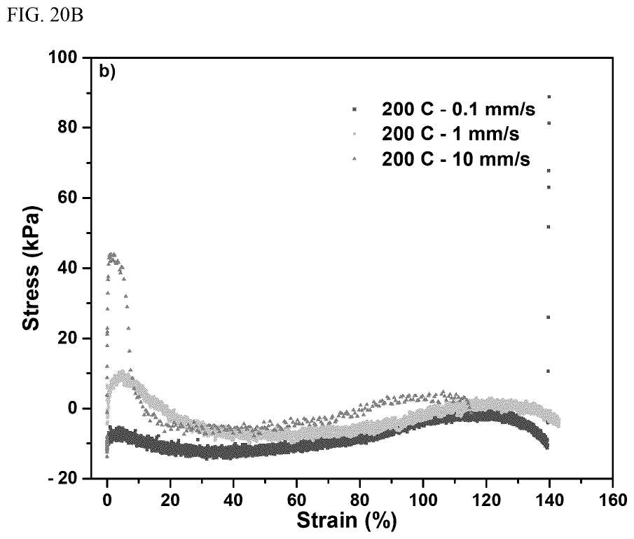

The percent shear from the expansion DMA experiments was considered as the point of mechanical failure. The recommended percent shear is considered as ˜10% less than the measured values for appropriate expansion. The shear behaviors are shown in FIGS. 20A and 20B. It was observed that that the stress for elongation was several orders of magnitude lower than is typically observed for PTFE materials. For example, convention PTFE materials exhibit forces in the 2-5 MPa range when expanded under comparable conditions. On the other hand, ceramic materials, of which CARULITE may be considered, generally do not undergo expansion in any form. Ceramic materials are prone to shrinkage and sintering when heat is applied. One would expect high-loaded ceramics to deteriorate when under strain given their rigid nature. As was apparent, however, the machined tapes could be elongated, effectively demonstrating that their viscoelastic behaviors are neither comparable to ceramic phases nor conventional PTFE.

In FIGS. 20A and 20B, the sharp drop in stress after the yield point is most likely a result of breaking up the ceramic “skin” and the PTFE is the main driver for further expansion. When stretched at 175 degrees Celsius, higher strain rates allowed for greater elongation. The long plateau region for both 1 mm/s and 10 mm/s expansion rates from roughly 50%-110% strain is indicative of plastic flow, more specifically of nonequilibrium steady flow. This flow is characterized by the disruption of the amorphous regions where polymer chains shear and/or straighten out allowing for expansion of the material. When stretched at 200 degrees Celsius, the plastic flow regime is much longer and requires less force to achieve. The stress observed throughout the plastic flow regime hovers around 0 kPa, which is likely around the instrument's detection levels. This indicates that the force needed expansion and flow is very low. 200 degrees Celsius is far enough above the Tg of PTFE that the material behaves in more of a soft rubbery state allowing for easy flow and deformation of the amorphous regions. Complete deformation and alignment in the amorphous regimes allowed for the formation of PTFE nanofibrils. These PTFE nanofibrils arose from the alignment of polymer chains and remaining crystalline regimes of the PTFE. Alignment of the polymer chains can be seen from the slight increase in stress at high strain % which represents a strain hardening regime in FIG. 20B.

Given the atypical expansion behavior observed on DMA of the machined matrix, and to confirm fibril expansion was truly achieved, SEM images were collected of the expanded matrixes (expanded tapes). Machined matrixes that were cut in a parallel plane to the machined direction (0 degrees cut; the machined direction and the expanded direction were the same) and expanded at 175 degrees Celsius, FIGS. 21A, 21B, and 21C clearly demonstrated fibrillation becomes more favorable as the rate is decreased. For example, the surface remained largely nonporous when the rate was 10 mm/s, which can be considered 200% elongation per second relative to the 1 cm piece of material (FIG. 21A). Decreasing the stretch rate by one order of magnitude to 1 mm/s (110% elongation/sec) began to open the surface, however, clear severance of the PTFE fibrils could be seen across the newly formed surface openings (FIG. 21B). By contrast, expanding the material at 0.1 mm/s (101% elongation/sec) did not sever the fibrils; instead leading to extremely well-oriented fibrils with discernable length and uniform width (FIG. 21C). As noted herein, the expansion conditions for the machined matrixes (tapes) in this Example were dissimilar from those of conventional PTFE stretching where literature indicates a stretching can be performed anywhere between 30-5000% elongation per second, depending on properties of the PTFE used and desired final porosity.

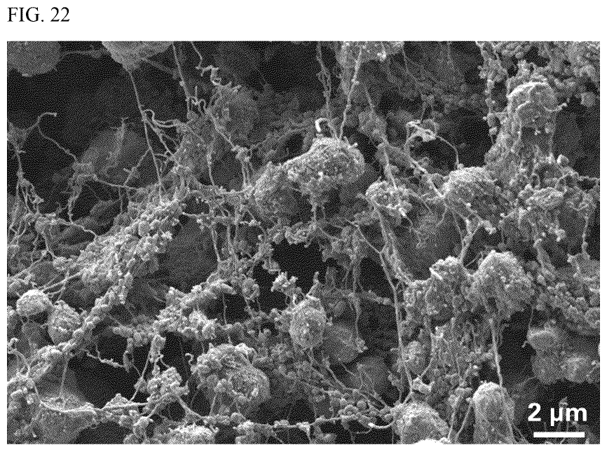

Without wishing to be bound by theory, the above expansion behavior and its associated dissimilarity to that of either the particle or PTFE phases may be explained by the interfacing between the short-strand PTFE fibrils, the long-strand PTFE fibrils, and the solid phase. Specifically, a comparison of an expanded matrix of the present Example (175 degrees Celsius, 0.1 mm/s, 0 degrees cut angle; FIG. 22) to a conventionally formed PTFE membrane free of solid particles (FIG. 14) suggests some similar binding mechanism between the two. For example, FIG. 14 demonstrates the well-known phenomena wherein PTFE resins self-adhere at spaced localities (nodes) with taught PTFE fibers of discernable width being present therebetween. The expanded matrix (expanded tape) displayed comparable networking after expansion (FIG. 13), whereby the active particles acted as the PTFE bond nodes instead of node formation being enacted by the fibrils, themselves. It is thought that such networking explains the unusual expansion behavior and structural flexibility of the machined and expanded matrixes. Regarding the unusual expansion behavior, it is theorized that the particles acting as PTFE nodes enable the tensile force to apply on the active particles rather than the PTFE fibers, thus incurring fibril expansion at vastly reduced rate. At the same time, the mechanical flexibility of the machined matrix and expanded matrix may be due to the PTFE fibrils acting in a similar way to ceramic bridges, whereby they ensure that all phases are mechanically tethered at the microscopic level. However, given that PTFE is flexible, whereas conventionally sintered ceramic bridges are rigid, the machined matrix and the expanded matrix tape retain rubber-like qualities. This type of bonding may be explained as a form of cold sintering, with the sintering process being achieved by a flexible binding phase in-lieu of rigid clay adhesives such as porcelain, bentonite, kaolinite, or others.

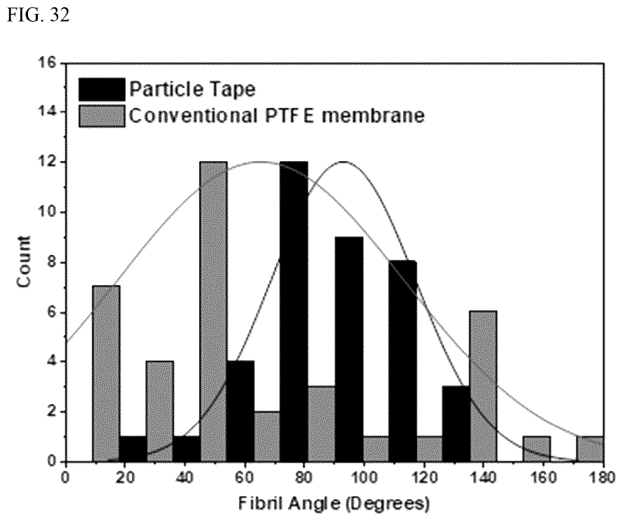

The angles of fibrils direction relative to the x-axis in FIG. 14 and FIG. 22 were determined using ImageJ software. Specifically, a comparison of the angles of fibrils in the present Example (175 degrees Celsius, 0.1 mm/s, 0 degrees cut angle; FIG. 22) to a conventionally formed PTFE membrane free of solid particles (FIG. 14) suggests the expanded matrix (expanded tape) demonstrates a narrowed direction of fibril orientation in-parallel to the machine direction. By contrast, conventionally manufactured PTFE tapes show a more random orientation of the fibril angle (FIG. 32). This phenomenon may be due to the manner which facilitates the PTFE-PTFE binding is different from that form the particle/PTFE networking.

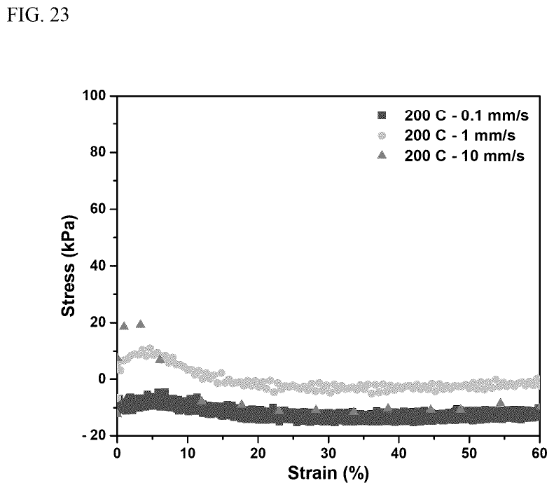

The DMA profiles of expansion of machined matrixes expanded at an expanded direction and the machined direction define an angle of 90 degrees are shown in FIG. 23 (expansion performed at 200 degrees Celsius). Stress was again found to increase with the expansion rate, but the overall expansion behavior was still inconsistent with that of either ceramic or conventional PTFE-based materials lacking active particles. That said, the elongation behavior was relatively consistent with that in FIGS. 20A and 20B. Specifically, a similar order of magnitude and relationship between pull rate and stress was observed.

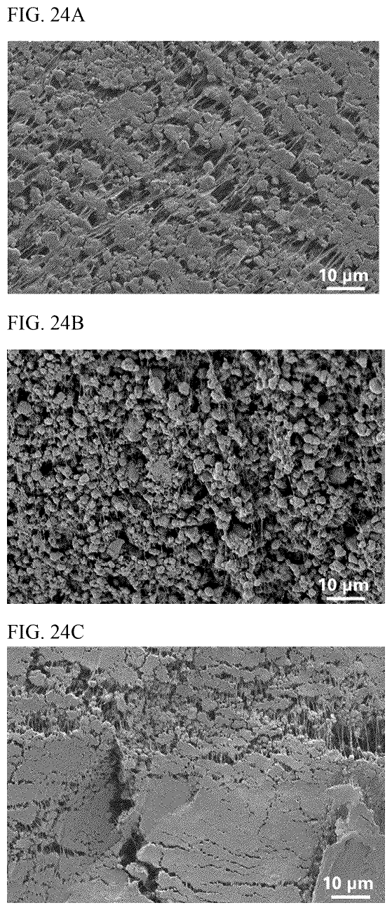

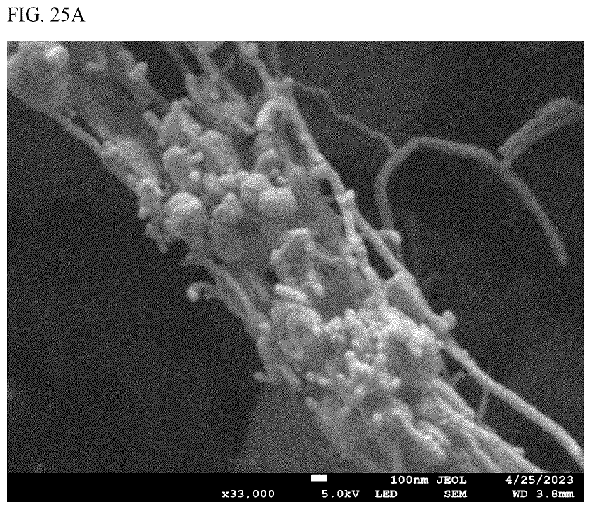

The microstructure expanded matrixes formed from machined matrixes expanded at an expanded direction and the machined direction define an angle of 90 degrees are shown in FIGS. 24A, 24B, and 24C (expansion performed at 200 degrees Celsius). Unlike expanded matrixes formed from expanding a machined matrix in an expanded direction that was the same as the machined direction, no clear relationship was observed between the expansion rate and microstructure. The 0.1 mm/s expansion rate yielded superior fibril expansion; however, it was unclear to what extent the lower expansion rate opened the catalyst layer (FIG. 24A). An enhancement in porosity seemed to be more present at when the expansion rate was 1.0 mm/s (FIG. 24B) with the worst porosity being present at the fasted expansion rate (10.0 mm/s; FIG. 24C). This result suggested that an expanded direction that is similar to the machined direction, may yield a microstructure that is more permeable than if the expanded direction was drastically different than the machined direction.

### Example 8: Tapes have a Plurality of Pores

This Example described the process and properties of machined matrixes having a plurality of through pores. The machined matrixes were formed from fibrous matrix 6 that was machined according to Example 2 in a singular machined direction. The machined matrix was punctured using a needle roller with 540 needles of 250 micrometers diameter.

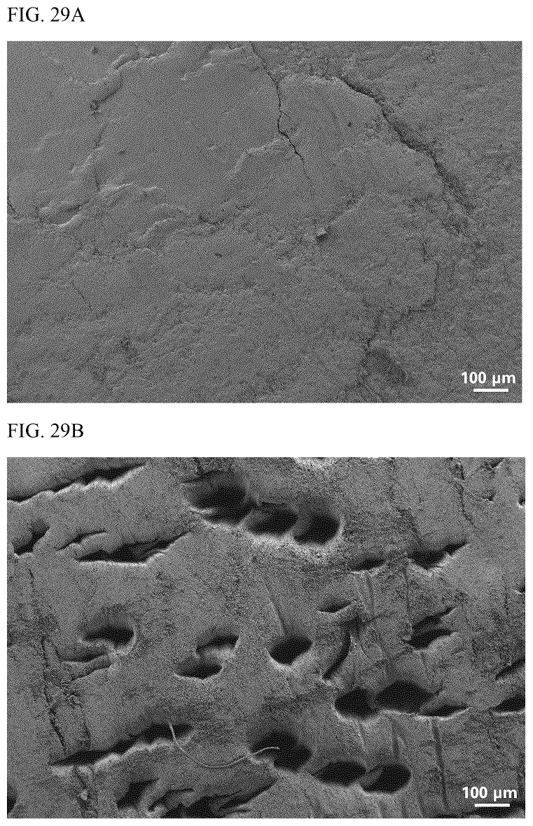

The machined matrix was imaged before (FIG. 29A) and after needling (FIG. 29B). The needle rolling opened the surface of the machined matrix by pushing aside the PTFE fibril/particle system. It should be noted here that the tape was not observed as sticking to the needles, likely due to PTFE being nonstick in general. The lack of sticking suggested that the machined matrix material rearranged rather than undergoing material loss. The needle puncturing also exfoliated the surface of the machined matrix, as demonstrated by the rough surface texture in FIG. 29B. The needled machined matrix is expected to have enhanced activity and diffusive properties by way of i) exfoliating the particle phase to space out the active material and ii) by providing high-permeability pathways into the nonwoven material depth through the newly formed punch pores.

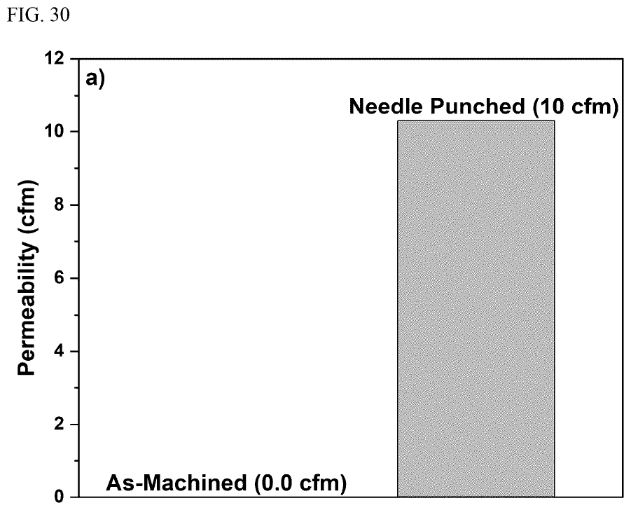

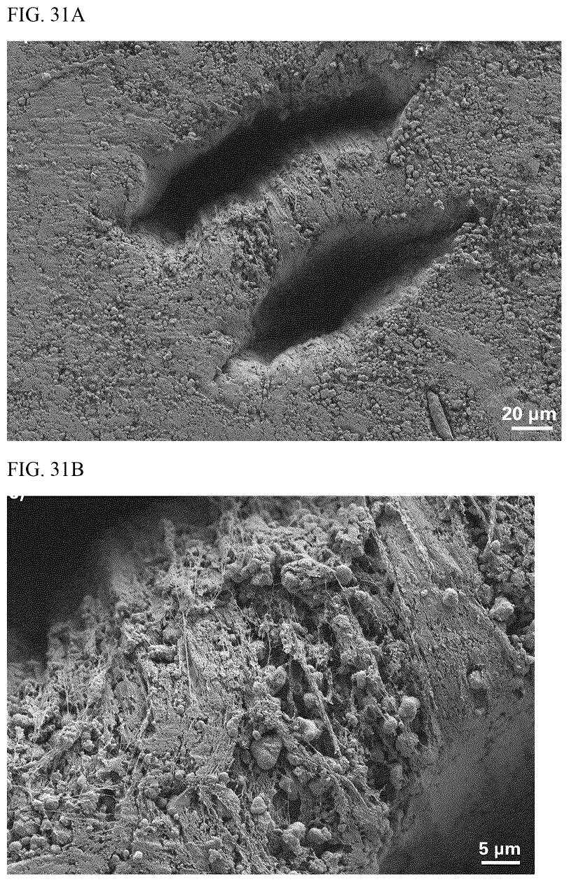

Assessment of the permeability before and after needle puncturing revealed that the punched sample increased in permeability from 0.0 cfm to 10.3 cfm at 125 Pa as measured according to the Air Permeability Test Method (FIG. 30). Furthermore, increased particle accessibility can be seen in FIG. 31A and FIG. 31B, where PTFE fibrils and active particles were observed in and around the localities of needling. Such effects exhibit that needling also opens the PTFE fibril/active particle network at the microscopic level, which can enhance catalytic activity by way of ensuring active phase accessibility.

What is claimed is:

1. A tape comprising:
a machined matrix having a machined direction, the machined matrix comprising:
long-strand PTFE fibrils forming an oriented network comprising the long-strand PTFE fibrils, the long-strand PTFE fibrils defining a longitudinal direction;
nodes distributed among the oriented network, the nodes comprising active particles and short-strand PTFE distributed among the active particles; and
a plurality of through pores having an average pore opening of 50 micrometers or greater.

2. The tape of claim 1, wherein the machined matrix has a density of the plurality of through pores and the density is 1 pore per square cm to 1000 pores per square cm.

3. The tape of claim 1, wherein the tape has an air permeability of 1 cfm or greater at 125 Pa.

4. The tape of claim 1, wherein the longitudinal direction and the machined direction of the machined matrix define an angle of 0 degrees to 20 degrees.

5. The tape of claim 1, wherein 90% or greater of the long-strand PTFE fibrils are oriented at an angle of 0 degrees to 20 degrees relative to the machined direction.

6. The tape of claim 1, wherein the machined matrix comprises 60 wt-% or greater of the active particles.

7. The tape of claim 1, wherein the active particles comprise a catalyst, an electroactive material, an absorbent, an adsorbent, a growth seed, a metal-organic framework, or a combination of two or more thereof; and wherein the adsorbent is a physisorbent, a chemisorbent, or a physisorbent-chemisorbent hybrid.

8. An expanded tape comprising:
an expanded matrix having an expanded direction, the expanded matrix comprising:
long-strand PTFE fibrils forming an oriented network comprising the long-strand PTFE fibrils, the long-strand PTFE fibrils defining a longitudinal direction; and
nodes distributed among the oriented network, the nodes comprising active particles and short-strand PTFE distributed among the active particles; and
a plurality of through pores having an average size of 50 micrometers or greater.

9. The expanded tape of claim 8, wherein the machined matrix has a density of the plurality of through pores and the density is 1 pore per square cm to 1000 pores per square cm.

10. The expanded tape of claim 8, wherein the tape has an air permeability of 1 cfm or greater at 125 Pa.

11. The expanded tape of claim 8, wherein the longitudinal direction and expanded direction define an angle of 0 degrees to 20 degrees.

12. The expanded tape of claim 8, wherein 90% or greater of the long-strand PTFE fibrils are oriented at an angle of 0 degrees to 20 degrees relative to the expanded direction.

13. The expanded tape of claim 8, wherein the expanded matrix comprises 60 wt-% or greater of the active particles.

14. The expanded tape of claim 8, wherein the expanded matrix comprises 80 wt-% or greater of the active particles.

15. The expanded tape of claim 8, wherein the active particles comprise a catalyst, an electroactive material, an absorbent, an adsorbent, a growth seed, a metal-organic framework, or a combination of two or more thereof; and wherein the adsorbent is a physisorbent, a chemisorbent, or a physisorbent-chemisorbent hybrid.

16. The expanded tape of claim 15, wherein the catalyst is capable of ozone destruction.

17. A method of making an expanded tape, the method comprising:
machining a fibrous matrix in a machined direction to form a machined matrix, the fibrous matrix comprising:
short-strand PTFE fibrils;
long-strand PTFE fibrils; and
active particles;
expanding the machined matrix in the expanded direction to form an expanded matrix; and
forming a plurality of pores to form the expanded tape.

18. The method of claim 17, wherein the machined direction and a longitudinal direction and the expanded direction define an angle of 0 degrees to 20 degrees.

19. The method of claim 17, wherein forming a plurality of pores further comprises puncturing the expanded matrix with a puncturing device.

20. The method of claim 19, wherein the puncturing device comprises a needle, a pressurized gas, pressurized water, or any combination thereof.
